(19) United States
(12) Patent Application Publication
(10) Pub. No.: US 2026/0339251 A1
(43) Pub. Date: Oct. 29, 2026

(54) IMAGE FORMING APPARATUS

(71) Applicant: CANON KABUSHIKI KAISHA, Tokyo (JP)

(72) Inventors: KEISUKE ISHIZUMI, Kanagawa (JP); TAKESHI SHIMBA, Kanagawa (JP); NORIHIRO MATSUMOTO, Tokyo (JP)

(21) Appl. No.: 19/653,671

(22) Filed: Apr. 21, 2026

(30) Foreign Application Priority Data
Apr. 28, 2025 (JP) 2025-074884

(51) Int. Cl. G03G 15/00; G03G 15/16; G03G 21/10

(52) U.S. Cl. CPC G03G 15/5054; G03G 15/161; G03G 15/5029; G03G 21/10; G03G 2215/00734; G03G 2215/1661

(57) ABSTRACT

In an image forming apparatus, a region of an image bearing member where a developer bearing member and the image bearing member come into contact with each other to form a development portion as the image bearing member rotates is defined as a first region, a region of an intermediate transfer member that forms a primary transfer portion with the first region as the image bearing member and the intermediate transfer member rotate is defined as a second region, and in a case where the second region forms a secondary transfer portion as the intermediate transfer member rotates, within the second region, a region of the intermediate transfer member where a transfer member and the intermediate transfer member come into contact with each other in the secondary transfer portion is defined as a third region. The controller controls to calculate residual toner in the third region.

### BACKGROUND

### Field of the Technology

The present disclosure relates to an image forming apparatus, such as a printer, a copying machine, a facsimile apparatus, a multifunction peripheral having a plurality of functions of these apparatuses, or the like, using an electrophotographic method or an electrostatic recording method.

### Description of the Related Art

Conventionally, for example, in an image forming apparatus such as a printer or the like using an electrophotographic method, an electrostatic latent image is formed on a photosensitive member, and charged toner that is a color material is supplied to the electrostatic latent image and developed, thereby forming a toner image on the photosensitive member. This toner image is transferred directly or via an intermediate transfer member to a recording material such as paper or the like and fixed, thereby forming an image on the recording material. In such an image forming apparatus, there is a case where a waste toner box is provided that stores untransferred toner (referred to as “transfer residual toner”) not transferred from an intermediate transfer member to a medium (also referred to as a “recording material”) such as paper or the like as waste toner.

Japanese Patent Laid-Open No. 2006-330460 describes a mechanism for detecting the amount of waste toner in a waste toner box installed in an image forming apparatus, thereby determining the time for replacement and detecting the timing when the waste toner box is full of waste toner. Japanese Patent Laid-Open No. 2006-330460 describes a method for detecting the amount of toner used to form an image formed by coming out of an end portion of paper in so-called borderless printing for performing printing without forming a margin in a recording material. Further, Japanese Patent Laid-Open No. 2006-330460 also describes a method for, regarding transfer residual toner remaining when toner is transferred from an intermediate transfer member to paper, taking into account a change in the transfer efficiency of the transfer of the toner on the intermediate transfer member to the recording material depending on the paper type of the recording material, the print environment, or the like, and correcting the amount of transfer residual toner.

The configuration of Japanese Patent Laid-Open No. 2006-330460, however, has the following issue. Japanese Patent Laid-Open No. 2006-330460 does not consider the influence of so-called fog toner, which is obtained by unexpectedly supplying toner to a photosensitive drum by contact between a development roller and the photosensitive drum in a region where a toner image is not formed. Accordingly, a need exists to predict the amount of waste toner in a waste toner box taking into account fog toner with high accuracy.

### SUMMARY

The present disclosure addresses these issues and is directed to predicting the amount of waste toner box taking into account fog toner with high accuracy. In summary, the present disclosure provides an image forming apparatus configured to execute an image forming operation for forming an image on a recording material. The image forming apparatus includes features characterized as an image bearing member, a charging member configured to charge a surface of the image bearing member, a development container configured to store toner, a developer bearing member configured to form a development portion by coming into contact with the image bearing member and to supply the toner charged to a normal polarity to the surface of the image bearing member in the development portion, a development voltage application section configured to apply a development voltage to the developer bearing member, an intermediate transfer member configured to form a primary transfer portion by coming into contact with the image bearing member and to which the toner is transferred from the image bearing member in the primary transfer portion, a transfer member configured to form a secondary transfer portion by coming into contact with the intermediate transfer member and to transfer the toner transferred to a surface of the intermediate transfer member to a recording material in the secondary transfer portion, a collection member configured to collect residual toner remaining on the surface of the intermediate transfer member without being transferred to the recording material in the secondary transfer portion, a toner storage section configured to store the residual toner collected by the collection member, a calculation section configured to calculate an amount of the residual toner stored in the toner storage section, a driving section configured to rotate the image bearing member and the intermediate transfer member, and a control section configured to control the development voltage application section and the driving section, wherein a region of the image bearing member where the developer bearing member and the image bearing member come into contact with each other to form the development portion as the image bearing member rotates is defined as a first region, wherein a region of the intermediate transfer member that forms the primary transfer portion with the first region as the image bearing member and the intermediate transfer member rotate is defined as a second region, wherein, in a case where the second region forms the secondary transfer portion as the intermediate transfer member rotates, within the second region, a region of the intermediate transfer member where the transfer member and the intermediate transfer member come into contact with each other in the secondary transfer portion is defined as a third region, wherein the control section performs control so that a potential difference formed between the developer bearing member and a surface potential formed in the first region in a case where the first region forms the development portion is a potential difference that causes an electrostatic force to act in a direction in which the toner charged to the normal polarity moves from the image bearing member toward the developer bearing member, and wherein the control section performs control to calculate the residual toner in the third region.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view of an image forming apparatus according to a first embodiment.

FIG. 2 is a block diagram illustrating a control configuration of the image forming apparatus according to the first embodiment.

FIG. 3 is a diagram for describing potential relationships on a surface of a photosensitive drum according to the first embodiment.

FIGS. 4A and 4B are diagrams illustrating relationships between a document size, an output size, and a printing region according to the first embodiment.

FIG. 5A is a perspective view of an intermediate transfer belt unit according to the first embodiment, and FIG. 5B is a perspective view of a waste toner storage section according to the first embodiment.

FIG. 6 is a diagram illustrating a relationship between a document size and a printing region in a width direction of the intermediate transfer belt according to the first embodiment.

FIG. 7 is a diagram illustrating a relationship between a pixel amount and an amount of waste toner when printing is performed on a recording material of a letter (LTR) size according to the first embodiment.

FIG. 8 is a timing chart of various operations according to the first embodiment.

FIG. 9 is a graph illustrating durability progression of the amount of waste toner with respect to each toner printing rate and each intermittent operation according to the first embodiment.

FIGS. 10A and 10B are diagrams for comparing printing regions of the LTR size and an A5 size according to the first embodiment.

FIGS. 11A to 11C are diagrams illustrating a relationship between image patterns of different sizes according to a second embodiment.

FIG. 12 is a diagram illustrating a placement configuration of width detection sensors for a recording material according to the second embodiment.

FIGS. 13A to 13C are diagrams illustrating a relationship between image patterns of different sizes according to the second embodiment.

FIG. 14A is a diagram illustrating regions of fog toner according to the first embodiment, and FIG. 14B is a diagram illustrating the regions of the fog toner in a longitudinal direction according to the first embodiment.

### DESCRIPTION OF THE EMBODIMENTS

An image forming apparatus according to various exemplary embodiments, features, and aspects of the present disclosure will be described in further detail below with reference to the drawings. However, the dimensions, the materials, the shapes, the relative arrangement, and the like of components described in the following embodiments may be appropriately changed according to the configuration of an apparatus to which the disclosure is applied, or various conditions, and are not intended to limit the scope of the disclosure to the following embodiments.

### 1. Overall Configuration and Operation of Image Forming Apparatus

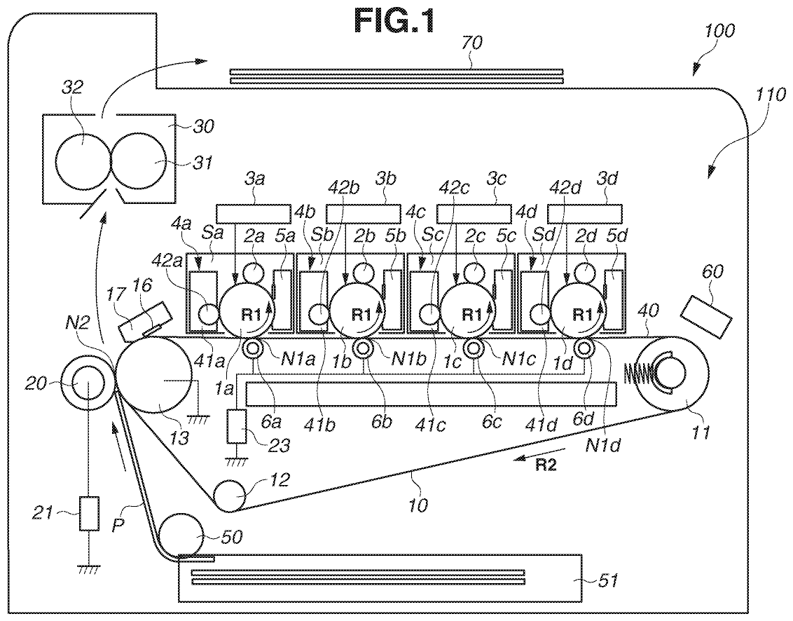

FIG. 1 is a schematic cross-sectional view of an image forming apparatus 100 according to a first embodiment. The image forming apparatus 100 according to the present embodiment is a tandem laser beam printer employing an intermediate transfer method and capable of forming a full-color image on a sheet-like recording material P using an electrophotographic method. For example, the image forming apparatus 100 forms an image on the recording material P based on a signal (information) input from an external apparatus 300 connected to the image forming apparatus 100, e.g., an image reading apparatus or a host computer such as a personal computer or the like.

The image forming apparatus 100 includes four image forming sections Sa, Sb, Sc, and Sd as a plurality of image forming sections (stations) in the image forming apparatus 100. The image forming sections Sa, Sb, Sc, and Sd form images using toner of yellow (Y), magenta (M), cyan (C), and black (K) colors, respectively. The four image forming sections Sa, Sb, Sc, and Sd are placed next to each other in a line at regular intervals in a direction (an approximately horizontal direction in the present embodiment) intersecting the vertical direction.

The configurations of the image forming sections S are substantially the same except for the colors of toner to be used. Components provided for the respective colors and having the same or corresponding functions or configurations are occasionally collectively described by omitting “a”, “b”, “c”, and “d” at the ends of reference numerals indicating components corresponding to the respective colors. For convenience, the relative magnitude (the relative height) of a voltage or a potential (or a potential difference) refers to the relative magnitude (the relative height) in a case where the voltage or the potential is compared in an absolute value, unless otherwise stated. In the image forming apparatus 100, paper is mainly used as the recording material P, and therefore, the recording material P is occasionally referred to as “paper”, but the recording material P includes a recording material formed of a material other than paper.

In the present embodiment, each image forming section S includes a photosensitive drum 1 (1a, 1b, 1c, and 1d), a charging roller 2 (2a, 2b, 2c, and 2d), a development device 4 (4a, 4b, 4c, and 4d), and the like.

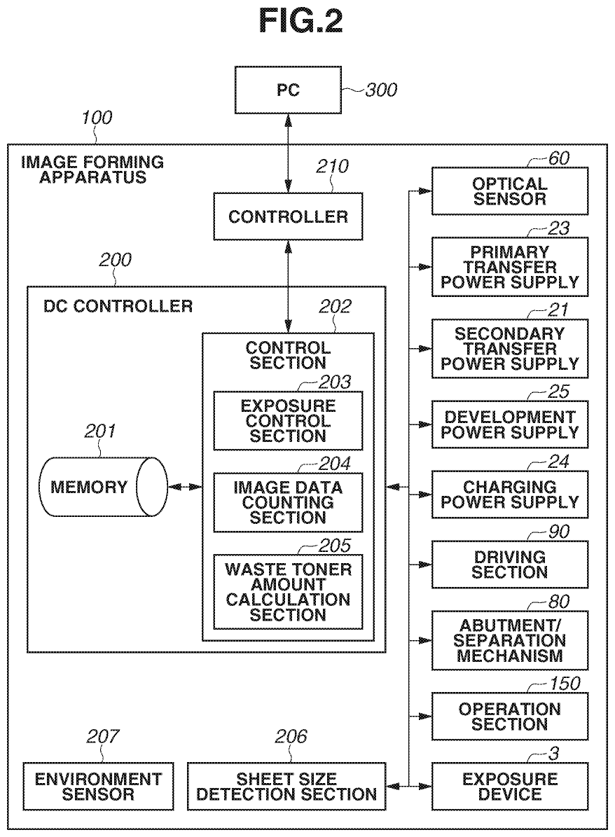

The photosensitive drum 1 that is a rotatable drum-type (cylindrical) photosensitive member (electrophotographic photosensitive member) as a first image bearing member that bears a toner image has an outer diameter of 24 mm. Then, the photosensitive drum 1 is rotationally driven at a predetermined peripheral speed (process speed) in the direction of an arrow R1 (the counterclockwise direction) in FIG. 1 by a driving force transmitted from a driving motor included in a driving section 90 (FIG. 2) as a driving unit.

In the present embodiment, the photosensitive drum 1 is rotationally driven at a peripheral speed of 200 millimeter per second (mm/sec). When a print job is started by a direct current (DC) controller 200 as a control section receiving an image signal, the rotational driving of the photosensitive drum 1 is started.

The rotating photosensitive drum 1 is uniformly subjected to a charging process to a predetermined potential (a dark potential Vd) having a predetermined polarity (a negative polarity in the present embodiment) by the charging roller 2 that is a roller-type charging member as a charging unit. The charging roller 2 is placed abutting the surface of the photosensitive drum 1 and pressed toward the photosensitive drum 1 by a predetermined pressing force. The charging roller 2 rotates driven according to the rotation of the photosensitive drum 1. In the charging process, a charging power supply (high-voltage power supply) 24 (FIG. 2) as a charging voltage application unit (a charging voltage application section) applies, to the charging roller 2, a charging voltage (a charging bias) that is a direct-current voltage having the same polarity (the negative polarity in the present embodiment) as the charging polarity of the photosensitive drum 1.

The surface of the rotating photosensitive drum 1 subjected to the charging process is scanned and exposed by the exposure device (laser scanner unit) 3 as an exposure unit according to the image signal, thereby forming an electrostatic latent image (an electrostatic image) of a color component corresponding to the image forming section S on the photosensitive drum 1. For example, when a full-color image is formed, the photosensitive drums 1a, 1b, 1c, and 1d are exposed according to image signals of color components corresponding to the respective image forming sections S by the exposure devices 3a, 3b, 3c, and 3d, respectively. This forms electrostatic latent images corresponding to color component images of yellow, magenta, cyan, and black for a target color image on the photosensitive drums 1a, 1b, 1c, and 1d, respectively.

Toner as a developer is supplied from the development device (development unit) 4 as a development unit to the electrostatic latent image formed on the photosensitive drum 1, thereby developing (visualizing) the electrostatic latent image and forming a toner image (a developer image) on the photosensitive drum 1. The development device 4 includes a development container 41 that stores toner that is a nonmagnetic one-component developer as a developer, and a development roller 42 as a development member (a developer bearing member). In the development, the development roller 42 is caused to abut the surface of the photosensitive drum 1. In the development, the development roller 42 is rotationally driven by a driving force transmitted from a driving motor included in the driving section 90 (FIG. 2) as the driving unit. In the present embodiment, the development roller 42 is rotationally driven at a peripheral speed of 300 mm/see in a rotational direction in which the surface of the development roller 42 moves in the same direction as the surface of the photosensitive drum 1 in an abutment portion between the photosensitive drum 1 and the development roller 42. The development roller 42 is thus rotated at a speed 1.5 times that of the photosensitive drum 1, whereby it is possible to stably perform the development. The surface of the development roller 42 is coated with the toner stored in the development container 41 and conveys the toner to a development position that is the abutment portion between the photosensitive drum 1 and the development roller 42. The outer diameter of the development roller 42 is 10 mm, and the development roller 42 is coated with the toner over a width direction of 220 mm. In the development, a development power supply (high-voltage power supply) 25 (FIG. 2) as a development voltage application unit (a development voltage application section) applies, to the development roller 42, a development voltage (a development bias) that is a direct-current voltage having the same polarity (the negative polarity in the present embodiment) as the charging polarity of the photosensitive drum 1. In the present embodiment, the normal charging polarity of the toner borne on the development roller 42 is the negative polarity. Then, in the present embodiment, the development device 4 attaches the toner charged to the same polarity (the negative polarity in the present embodiment) as the charging polarity of the photosensitive drum 1 by the charging roller 2 to a portion on the photosensitive drum 1 where the potential is decreased due to the exposure (an image portion) (a reversal development method).

The present disclosure, however, can also be applied to an image forming apparatus that performs development using toner charged to the opposite polarity to the charging polarity of the photosensitive drum 1.

In the present embodiment, the image forming apparatus 100 includes an abutment/separation mechanism 80 (FIG. 2) for causing the development roller 42 to abut the photosensitive drum 1 and to separate the development roller 42 from the photosensitive drum 1. In the present embodiment, for example, when the image forming apparatus 100 is stopped, the development roller 42 is separated from the photosensitive drum 1 by the abutment/separation mechanism 80. Then, in the development, the development roller 42 is caused to abut the photosensitive drum 1 by the abutment/separation mechanism 80. In the present embodiment, the development container 41 is configured to be swingable and is biased in the direction in which the development roller 42 abuts the photosensitive drum 1 by a pressurization spring that is a biasing member as a biasing unit. The abutment/separation mechanism 80 can separate the development roller 42 from the photosensitive drum 1 by moving the development container 41 (causing the development container 41 to pivot) against the biasing force of the pressurization spring. The abutment/separation mechanism 80 can also cause the development roller 42 to abut the photosensitive drum 1 by allowing the development container 41 to move (pivot) by the biasing force of the pressurization spring. The abutment/separation mechanism 80 is driven by a driving force transmitted from a driving motor included in the driving section 90 (FIG. 2) as the driving unit. When the development roller 42 is caused to abut the photosensitive drum 1, the development roller 42 is rotationally driven. When the development roller 42 is separated from the photosensitive drum 1, the rotation of the development roller 42 is stopped.

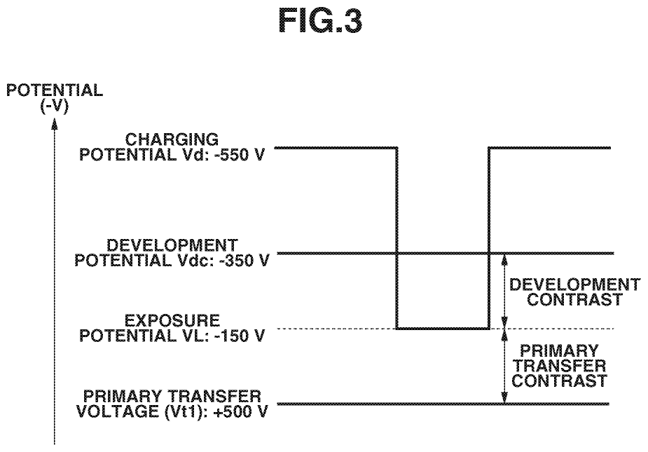

FIG. 3 is a schematic diagram illustrating the potential relationships on the photosensitive drum 1 according to the present embodiment. In the present embodiment, in a charging process, a charging voltage of −950 volts (V) is applied to the charging roller 2, whereby the surface of the photosensitive drum 1 is uniformly subjected to the charging process to a surface potential of −550 V (a charging potential or a dark potential Vd). In the present embodiment, the amount of exposure (the amount of laser light: microjoule per square centimeter (μJ/cm²)) of the exposure device 3 is set so that the surface potential (an exposure potential or a light potential VL) of the photosensitive drum 1 after being exposed by the exposure device 3 is −150 V. In the present embodiment, in development, a development potential Vdc is formed by applying a development voltage of −350 V to the development roller 42. In the present embodiment, a toner image forming unit that forms a toner image is composed of the charging roller 2, the exposure device 3, the development device 4, and the like of each image forming section S. Although a toner image is obtained by developing toner on the development roller 42 at the exposure potential, a part of the toner is developed from the development roller 42 to the photosensitive drum 1 also in a region other than a region at the exposure potential. This toner is termed “fog toner”. The fog toner will be described below.

An intermediate transfer belt 10 that is an intermediate transfer member composed of a rotatable endless belt as a second image bearing member that bears toner images is placed opposed to the four photosensitive drums 1.

In the image forming apparatus 100 according to the present embodiment, the ratio of a driving gear of each photosensitive drum 1 is adjusted so that the rotation speed of the intermediate transfer belt 10 is 0.5% faster than the rotation speed of the photosensitive drum 1. Regarding this difference in speed, the rotation speed of the intermediate transfer belt 10 may not be faster than the rotation speed of the photosensitive drum 1. The rotation speed of the intermediate transfer belt 10 may be set to be slower than the rotation speed of the photosensitive drum 1.

The intermediate transfer belt 10 is stretched around three shafts, namely a first stretching roller 11, a second stretching roller 12, and a third stretching roller 13, as a plurality of stretching rollers. The first stretching roller 11 and the third stretching roller 13 form a surface to which a toner image is transferred on the intermediate transfer belt 10. The first stretching roller 11 also functions as a tension roller that applies a predetermined tension to the intermediate transfer belt 10. The third stretching roller 13 functions as a driving roller that transmits a driving force to the intermediate transfer belt 10 and also functions as an opposing roller of a secondary transfer roller 20. To the intermediate transfer belt 10, a total tension of 60 newtons (N) is applied by the first stretching roller 11. The intermediate transfer belt 10 rotates (makes a circling movement or a circular movement) in the direction of an arrow R2 (the clockwise direction) in FIG. 1 by the third stretching roller 13 being rotationally driven by a driving force transmitted from a driving motor included in the driving section 90 (FIG. 2) as the driving unit. The intermediate transfer belt 10 is rotationally driven at a peripheral speed corresponding to the peripheral speed of the photosensitive drum 1. The first stretching roller 11 and the second stretching roller 12 rotate driven according to the rotation of the intermediate transfer belt 10. On the inner peripheral surface side of the intermediate transfer belt 10, primary transfer rollers 6a, 6b, 6c, and 6d that are roller-type primary transfer members as primary transfer units are placed corresponding to the photosensitive drums 1a, 1b, 1c, and 1d, respectively.

Each primary transfer roller 6 comes into contact with the inner peripheral surface of the intermediate transfer belt 10 and presses the intermediate transfer belt 10 toward the photosensitive drum 1, thereby forming a primary transfer portion (primary transfer nip) N1 that is an abutment portion between the photosensitive drum 1 and the intermediate transfer belt 10. The primary transfer roller 6 rotates driven according to the rotation of the intermediate transfer belt 10.

A toner image formed on the photosensitive drum 1 is transferred (primarily transferred) onto the intermediate transfer belt 10 as a rotating transfer target body by the action of the primary transfer roller 6 in the primary transfer portion N1 (N1a, N1b, N1c, and N1d). In the primary transfer, a primary transfer power supply (high-voltage power supply) 23 as a primary transfer voltage application unit (a primary transfer voltage application section) applies, to the primary transfer roller 6, a primary transfer voltage (a primary transfer bias) that is a direct-current voltage having the opposite polarity (a positive polarity in the present embodiment) to the normal charging polarity of the toner. In the present embodiment, as illustrated in FIG. 3, in the primary transfer, a primary transfer voltage (Vt1) of +500 V is applied to the primary transfer roller 6. The difference between −150 V that is the surface potential (the exposure potential or the light potential VL) of the photosensitive drum 1 after being exposed by the exposure device 3 and a primary transfer voltage of +500 V is referred to as a “primary transfer contrast”. The greater the primary transfer contrast is, the more likely the toner is to be transferred to the surface of the intermediate transfer belt 10. When, however, the primary transfer contrast is too great, discharge occurs in the primary transfer portion N1, and appropriate transfer may not be able to be performed. Thus, the primary transfer contrast needs to be appropriately set. When a full-color image is formed, toner images of yellow, magenta, cyan, and black colors formed on the four photosensitive drums 1a, 1b, 1c, and 1d are sequentially transferred in a superimposed manner on the intermediate transfer belt 10. This forms toner images of the four colors corresponding to a target color image on the intermediate transfer belt 10. Residual toner remaining on each photosensitive drum 1 without being transferred to the intermediate transfer belt 10 is collected by a cleaning unit 5 placed on the photosensitive drum 1. In the present embodiment, the primary transfer power supply 23 is a common power supply capable of applying a voltage having the positive polarity or the negative polarity to the four primary transfer rollers 6a, 6b, 6c, and 6d. The primary transfer power supply 23 can output a voltage having the positive polarity in the range of +100 V to +2000 V (“to” in a numerical range indicates a range including numerical values before and after “to”) and can output a voltage having the negative polarity in the range of −200 V to −2000 V. Although in the present embodiment, a configuration is described in which the common primary transfer power supply 23 applies a voltage to the plurality of primary transfer rollers 6, the present disclosure is not limited to this configuration. The present disclosure can also be applied to a configuration in which a plurality of primary transfer power supplies is provided corresponding to the respective primary transfer rollers 6.

In the present embodiment, the intermediate transfer belt 10 includes an endless belt (film) composed of two layers, namely a base layer and a surface layer. The base layer is a layer having a thickness of 70 μm formed of a material obtained by dispersing a quaternary ammonium salt, which is an ion conductive agent as an electrical resistance adjuster, into a polyethylene naphthalate resin and dispersing carbon black to give tint, and has an elastic modulus of 2000 mega pascal (Mpa). The surface layer is formed on the outer peripheral surface of the base layer, which is on the outer peripheral surface side of the intermediate transfer belt 10. The surface layer is a layer having a thickness of 3 μm formed of a material obtained by dispersing antimony-doped zinc oxide as an electrical resistance adjuster into an acrylic resin as a base material and adding polytetrafluoroethylene (PTFE) particles as a solid lubricant to the base material.

In the present embodiment, the volume resistivity of the intermediate transfer belt 10 is 1×10¹⁰ Ω·cm. The volume resistivity of the intermediate transfer belt 10 was measured at an applied voltage of 100 V for a measurement time of 10 seconds by connecting a UR probe (model: MCP-HTP12) to Hiresta-UP (MCP-HT450) manufactured by Mitsubishi Chemical Corporation. The environment of a measurement chamber where the volume resistivity of the intermediate transfer belt 10 was measured was set to a temperature of 23 degrees Celsius (°C) and a humidity (relative humidity) of 50%. Then, the volume resistivity of the intermediate transfer belt 10 after being left for four hours in the measurement chamber was measured. In the present embodiment, the glossiness of the surface (the outer peripheral surface) of the intermediate transfer belt 10 is 75. The glossiness of the surface of the intermediate transfer belt 10 was measured by a handy glossmeter IG-320 manufactured by Horiba, Ltd. In the present embodiment, the perimeter of the intermediate transfer belt 10 is 800 mm.

In the present embodiment, the primary transfer roller 6 is a roller having an outer diameter of 11 mm obtained by covering the periphery of a nickel-plated steel rod having an outer diameter of 5 mm with a foamed sponge member containing nitrile rubber (NBR) and epichlorohydrin rubber as main components and adjusted to a volume resistivity of 1×10⁵ ohm times centimeter (22 cm) and a thickness of 3 mm. In the present embodiment, the rubber hardness of the foamed sponge member constituting the primary transfer roller 6 was 20° with a load of 500 grams (g) in a case where the rubber hardness was measured using the ASKER Durometer Type C.

On the outer peripheral surface side of the intermediate transfer belt 10, a secondary transfer roller 20 that is a roller-type secondary transfer member as a secondary transfer unit is placed at a position opposed to the third stretching roller 13. The secondary transfer roller 20 comes into contact with the outer peripheral surface of the intermediate transfer belt 10 and is pressed by a pressurization force of 50 N toward the third stretching roller 13 placed at a position opposed to the secondary transfer roller 20 via the intermediate transfer belt 10. Consequently, the secondary transfer roller 20 forms a secondary transfer portion (secondary transfer nip) N2 that is an abutment portion between the intermediate transfer belt 10 and the secondary transfer roller 20.

The secondary transfer roller 20 rotates driven according to the rotation of the intermediate transfer belt 10. A toner image formed on the intermediate transfer belt 10 is transferred (secondarily transferred) onto the recording material P as a transfer target body conveyed while being nipped between the intermediate transfer belt 10 and the secondary transfer roller 20 in the secondary transfer portion N2. In the secondary transfer, a secondary transfer power supply 21 as a secondary transfer voltage application unit (a secondary transfer voltage application section) applies to the secondary transfer roller 20 a secondary transfer voltage (a secondary transfer bias) that is a direct-current voltage having the opposite polarity (the positive polarity in the present embodiment) to the normal charging polarity of the toner. The secondary transfer power supply (high-voltage power supply) 21 applies a voltage, whereby a current flows from the secondary transfer roller 20 to the third stretching roller 13. Consequently, the toner image borne on the surface of the intermediate transfer belt 10 is secondarily transferred to the recording material P in the secondary transfer portion N2. In the secondary transfer, the voltage applied to the secondary transfer roller 20 by the secondary transfer power supply 21 is controlled so that the current flowing from the secondary transfer roller 20 to the third stretching roller 13 via the intermediate transfer belt 10 is constant. The magnitude of the current for performing the secondary transfer is determined in advance depending on the installation environment (the surrounding environment) of the image forming apparatus 100 and the type of the recording material P. In the present embodiment, the secondary transfer power supply 21 can output a voltage in the range of +100 V to +4000 V. The third stretching roller 13 is electrically grounded (connected to a ground potential). The recording material (transfer material, recording medium, or medium) P such as paper, an overhead projector (OHP) sheet, or the like is stored in a cassette 51 as a recording material storage section. The recording material P is sent out from the cassette 51 by a feeding roller 50 as a feeding member or the like and conveyed to the secondary transfer portion N2 by a registration roller pair (not illustrated) as a conveyance member by matching the timings of the recording material P and the toner image on the intermediate transfer belt 10.

In the present embodiment, examples of the size of the recording material P that can be conveyed include letter (LTR), A4, and A5. A recording material having a grammage of 60 g/m² to 200 g/m² can be conveyed. The size and the grammage of the recording material P that can be conveyed that are illustrated in the present embodiment are merely examples, and the recording material P having a size or a grammage in a range other than that in the present embodiment may be able to be conveyed. For example, the image forming apparatus 100 may also be compatible with B5, B6, A6, duodecimo, or the like in addition to the above sizes. A method for identifying the size of the recording material P will be described below.

In the present embodiment, the secondary transfer roller 20 is a roller having an outer diameter of 18 mm obtained by covering the periphery of a nickel-plated steel rod having an outer diameter of 8 mm with a foamed sponge member containing NBR and epichlorohydrin rubber as main components and adjusted to a volume resistivity of 1×10⁸ Ω·cm and a thickness of 5 mm. In the present embodiment, the rubber hardness of the foamed sponge member constituting the secondary transfer roller 20 was 30° with a load of 500 g in a case where the rubber hardness was measured using the ASKER Durometer Type C.

The recording material P to which the toner image is transferred is conveyed to a fixing device 30 as a fixing unit. The fixing device 30 includes a fixing roller 31 having a heater (not illustrated) as a heat source built-in, and a pressure roller 32 that comes into pressure contact with the fixing roller 31. The fixing device 30 heats and pressurizes the recording material P bearing the unfixed toner image in a fixing section (a fixing nip) that is an abutment portion between the fixing roller 31 and the pressure roller 32, thereby fixing (melting and firmly fixing) the toner image to the recording material P. For example, when a full-color image is formed, toner images of the four colors on the recording material P are melted and mixed and are fixed onto the recording material P. The recording material P on which a print image is formed by fixing the toner images is discharged (output) to outside a housing of an apparatus main body 110 (outside the image forming apparatus 100) through a sheet discharge port (a recording material discharge port) as an opening portion formed in the housing of the apparatus main body 110. The recording material P is stacked on a tray 70 provided above the apparatus main body 110.

Toner remaining on the surface of the intermediate transfer belt 10 after the recording material P passes through the secondary transfer portion N2 is removed from the intermediate transfer belt 10 by a cleaning blade 16 as a collection member placed on the intermediate transfer belt 10. Then, this residual toner removed from the intermediate transfer belt 10 is stored in a cleaning unit 17 as a first toner collection container. Waste toner in the cleaning unit 17 as the first toner collection container is conveyed to a waste toner box 400 as a second toner collection container.

In the present embodiment, the intermediate transfer belt 10, the cleaning unit 17, the stretching rollers 11 to 13, the primary transfer rollers 6, and the waste toner box 400 are configured as a single intermediate transfer belt unit 40, and the intermediate transfer belt unit 40 can be replaced as desired. The intermediate transfer belt unit 40 and the waste toner box 400 will be described below.

The image forming apparatus 100 according to the present embodiment can form a full-color print image by the above operation. The image forming apparatus 100 according to the present embodiment can also form a monochromatic print image using only a single desired image forming section S, or form a multicolor print image using several image forming sections S among the plurality of image forming sections S.

In the present embodiment, in each image forming section S, the photosensitive drum 1, the charging roller 2 as a process unit that acts on the photosensitive drum 1, and the development device 4 are integrated and constitute a process cartridge S as an image forming section. The process cartridge S is attachable to and detachable from the image forming apparatus 100 via attachment units such as an attachment guide, a positioning member, and the like provided in the apparatus main body 110 of the image forming apparatus 100. Herein, the apparatus main body 110 and the process cartridge S are referred to together as the image forming apparatus 100. Although in the present embodiment, the image forming section S is a process cartridge attachable to and detachable from the image forming apparatus 100, a configuration may be employed in which the image forming section S is not attachable to and detachable from the image forming apparatus 100, but is fastened to the image forming apparatus 100.

In the image forming apparatus 100, an optical sensor 60 used to execute correction control for correcting the color misregistration and the density of an image to be formed in the image forming apparatus 100 is also provided. The optical sensor 60 is placed at a position downstream of the primary transfer portion N1 (the furthest downstream primary transfer portion N1d) and upstream of the secondary transfer portion N2 (a detection position) in the rotational direction R2 of the intermediate transfer belt 10. The optical sensor 60 is placed to mainly detect the states of the surface (the outer peripheral surface) of the intermediate transfer belt 10 and toner on the surface. In the present embodiment, the optical sensor 60 is placed at a position opposed to the first stretching roller 11 via the intermediate transfer belt 10.

In a case where continuous printing for continuously forming print images on a plurality of recording materials P is executed, the above operation is repeatedly performed. For example, in a case where print images are continuously formed on a plurality of LTR sheets, the image forming apparatus 100 according to the present embodiment executes continuous printing at an interval of 50 mm between the rear end of a preceding sheet and the front end of a subsequent sheet. In the following description, the interval between the rear end of the preceding sheet and the front end of the subsequent sheet is referred to as an “inter-sheet interval”. An operation in which the inter-sheet interval occurs is referred to as an “inter-sheet operation”. A time that occurs at this time is referred to as an “inter-sheet time”. The inter-sheet operation refers to an operation in which the photosensitive drum 1 and the development roller 42 rotate in contact with each other after an image forming operation is executed on a first recording material and before the image forming operation is executed on a second recording material subsequent to the first recording material.

### 2. Control Configuration

Next, the control configuration of the image forming apparatus 100 according to the present embodiment is described. FIG. 2 is a block diagram illustrating the outline of the control configuration for controlling the operation of the image forming apparatus 100 according to the present embodiment.

The external apparatus 300 gives a print command (a start instruction or various pieces of setting information) to a controller 210 that is a conversion section as a conversion unit provided within the image forming apparatus 100. Then, the external apparatus 300 transmits image data of a print image and size information regarding the specified recording material P to the controller 210. Thus, the controller 210 doubles as an acquisition unit as a first acquisition section that acquires the size information regarding the recording material P. The size information regarding the recording material P is also transmitted from the controller 210 to a control section 202. Then, the control section 202 processes correction due to the inconsistency between the detected size of the specified recording material P and the detected size of the actual recording material P. In the present embodiment, the external apparatus 300 is a personal computer (PC) that is a host computer. The controller 210 receives red, green, and blue (RGB) or cyan, magenta, yellow, and black (CMYK) image data from the external apparatus 300 and converts the image data according to an output size into CMYK exposure data (a CMYK image signal) according to a mode specified by the external apparatus 300. Hereinafter, a region of the recording material P defined according to the output size is referred to as a “printing region”. In the present embodiment, the exposure data converted at this time is 600 dots per inch (dpi). Examples of the mode specified by the external apparatus 300 include a mode regarding image quality in addition to the type and the size of paper and also include a mode of changing the number of lines of a dithering matrix.

When an exposure control section 203 converts the image data specified by the controller 210 into exposure data, a printing region according to the size information regarding the recording material P is determined.

The controller 210 transfers the converted exposure data to the exposure control section 203 as an exposure control unit provided within the image forming apparatus 100 and included in the control section 202 and controls the exposure device 3. The image forming apparatus 100 according to the present embodiment controls a halftone density by adjusting the on/off area of the exposure data. When the control section 202 receives a print command from the controller 210, the control section 202 performs control to start a print job.

An image data counting section 204 provided within the control section 202 counts the number of times the exposure data is turned on or off (hereinafter referred to as “pixel counts”).

A direct current (DC) controller 200 has the control section 202, a memory (storage section) 201 including a read-only memory (ROM), a random-access memory (RAM), and the like as storage units, and the like. The DC controller 200 controls the operations of the components of the image forming apparatus 100 by the control section 202 executing processing according to a program and data stored in advance in the memory 201. For example, the DC controller 200 (the control section 202) controls the charging power supply 24, the development power supply 25, the exposure control section 203 (the exposure device 3), the primary transfer power supply 23, the secondary transfer power supply 21, the driving section 90, the abutment/separation mechanism 80, and the like. Then, for example, the DC controller 200 (the control section 202) forms an electrostatic latent image and transfers a developed toner image, thereby forming an image. To the DC controller 200 (the control section 202), an operation section 150 provided in the image forming apparatus 100 is also connected. The operation section 150 includes a display section as a display unit that displays information under control of the DC controller 200 (the control section 202). Then, the operation section 150 includes an input section as an input unit that inputs information to the DC controller 200 (the control section 202) by an operation of an operator such as a user or a service person.

The operation section 150 may include a touch panel that functions as both the display unit and the input unit.

A waste toner amount calculation section 205 is also provided within the control section 202. The waste toner amount calculation section 205 calculates the amount of waste toner that would be stored in the waste toner box 400, and notifies the controller 210 of the state according to the amount of waste toner. The waste toner amount calculation section 205 calculates the amount of waste toner assumed based on the number of pixel counts and the amount of waste toner assumed to be fog toner.

The amount of waste toner due to fog toner outside a printing region is calculated based on an abutment time in which the development roller 42 abuts the photosensitive drum 1. A method for calculating the amount of waste toner will be described below.

When the DC controller 200 (the control section 202) executes correction control for correcting the color misregistration and the density of an image to be formed in the image forming apparatus 100, the DC controller 200 (the control section 202) performs the process of receiving a signal from the optical sensor 60. For example, in the correction control, the optical sensor 60 detects the amount of reflected light from a test pattern (a detection toner image) formed on the outer peripheral surface of the intermediate transfer belt 10 at a position opposed to the optical sensor 60. The output of a detection signal indicating the result of the detection of the amount of reflected light by the optical sensor 60 is 0 V to 3.3 V. The DC controller 200 (the control section 202) performs calculation using the result of the detection of the optical sensor 60 and corrects the density and the color registration. In the present embodiment, as a method for the density correction control, the DC controller 200 (the control section 202) creates a correction curve for an image signal that enables the obtaining of a desired density curve based on the result of the detection of a test pattern for detecting the density (a density control correction pattern). In the present embodiment, as a method for the color registration correction control, the DC controller 200 (the control section 202) corrects the image forming timing of each color based on the result of the detection of a test pattern for detecting the amount of color misregistration (a registration correction pattern). For the color registration correction control and the density correction control, execution conditions according to changes in predetermined temperature and humidity, the number of printed sheets (the number of passed sheets), and the like are set in advance, and when the execution conditions are satisfied, the color registration correction control and the density correction control are executed.

In the present embodiment, as described above, the primary transfer power supply 23 is made common to the four image forming sections S. In the present embodiment, although not illustrated in FIG. 1, the charging power supply 24, the development power supply 25, and the abutment/separation mechanism 80 are independently provided for each image forming section S. Each of the charging power supply 24, the development power supply 25, and the abutment/separation mechanism 80 may be made common to at least some of the image forming sections S. The driving section 90 includes driving motors as driving sources and drive transmission members. The driving section 90 includes driving motors that drive the photosensitive drum 1, members of the development device 4, such as the development roller 42 and the like, the intermediate transfer belt 10 (the third stretching roller 13), the abutment/separation mechanism 80, and the like. Each of the driving motors that drive these members may be independently provided, or driving motors that drive at least some of these members may be made common. Each of the driving motors that drive the members for the respective colors may be independently provided, or driving motors that drive the members for at least some of the colors may be made common.

The image forming apparatus 100 also includes an environment sensor 207 that detects the environment around the image forming apparatus 100.

The environment sensor 207 is a sensor that detects the temperature and the humidity around the image forming apparatus 100. The control section 202 performs control to change the weighting of the amount of waste toner based on the detection result of the environment sensor 207. The environment sensor 207 may be a temperature sensor, or may be a humidity sensor.

A print job (a print operation, a print sequence, an image forming operation, and an image forming sequence) is a series of operations started according to a single start instruction for forming images on one or more recording materials P and outputting the images. The print job generally includes an image forming step, a pre-rotation step, an inter-sheet step in a case where images are formed on a plurality of recording materials P, and a post-rotation step. The image forming step refers to a period when an electrostatic latent image of an image to be actually formed on a recording material P and output is formed, a toner image is developed, and the toner image is primarily transferred and secondarily transferred. An image forming time refers to this period.

More particularly, the pre-rotation step is a period when a preparation operation before the image forming step is performed, from when a print start instruction is input to when a toner image actually starts to be developed. As described above, the inter-sheet step is a period corresponding to, when images are continuously formed on a plurality of recording materials P (when continuous printing is performed), a period between the recording materials P. The post-rotation step is a period when an arrangement operation (a preparation operation) after the image forming step is performed. A non-image forming time is a period other than the image forming time and includes the pre-rotation step, the inter-sheet step, and the post-rotation step, and further includes a pre-multi-rotation step that is a preparation operation when the image forming apparatus 100 is powered on or when the image forming apparatus 100 returns from a sleep state, and the like. A pre-rotation operation, an image forming operation, an inter-sheet operation, and a post-rotation operation performed in the pre-rotation step, the image forming step, the inter-sheet step, and the post-rotation step, respectively, will be described in detail below.

### 3. Setting of Size of Recording Material

Next, a description is given of a method for identifying the size of the recording material P to be passed. In the present embodiment, exposure data is generated according to the size of the recording material P specified by a printer driver mounted on the external apparatus 300.

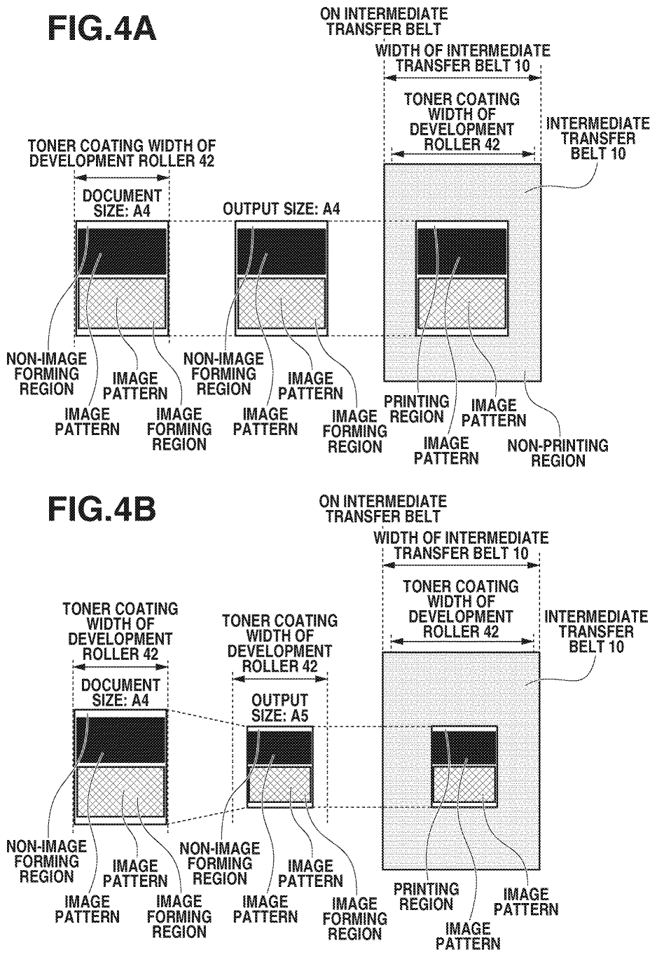

FIGS. 4A and 4B are diagrams illustrating the relationships between the document size of a document to be printed, the size of the recording material P specified by the printer driver, and a printing region on the intermediate transfer belt 10.

FIG. 4A illustrates an example of a case where the document size and the output size are both specified as the A4 size.

For example, the document size described here refers to an image size specified by an application in the PC, such as Word or PowerPoint manufactured by Microsoft Corporation or the like. The output size refers to a size specified as a print image by the printer driver or the like.

In FIG. 4A, the document size is equal to the output size. Thus, the region of image forming patterns in the output size is equal to that in the document size. Thus, the external apparatus 300 transmits image information corresponding to the A4 size to the controller 210, and the control section 202 defines a printing region corresponding to the A4 size.

The printing region refers to a region of the recording material P. A region outside the printing region that is a non-printing region refers to a region other than the region of the recording material P. Then, an image forming region and a non-image forming region are present inside the printing region. To the image forming region, a toner image formed based on an exposure pattern is transferred. On the other hand, in the non-image forming region, the toner image based on the exposure pattern is not formed. Although the printing region and the image forming region are regions of the recording material P, regions of the surface of the intermediate transfer belt 10 corresponding to the regions of the recording material P may be used as targets, or regions of the surface of the photosensitive drum 1 corresponding to the regions of the recording material P may be used as targets.

First, a toner image formed based on an exposure pattern defined corresponding to the image forming region in the printing region is primarily transferred from the photosensitive drum 1 onto the intermediate transfer belt 10 in the primary transfer portion N1. In a region corresponding to the non-image forming region in the printing region on the intermediate transfer belt 10 illustrated in FIG. 4A, the toner image is not formed, but fog toner is formed. Then, the toner image and the fog toner are transferred from the intermediate transfer belt 10 to the recording material P of the A4 size in the secondary transfer portion N2. On the other hand, toner not transferred from the intermediate transfer belt 10 to the recording material P of the A4 size in the secondary transfer portion N2 becomes waste toner as residual toner. On the intermediate transfer belt 10, fog toner is formed in a region according to the toner coating width of the development roller 42 illustrated in FIG. 4A, and therefore, fog toner is also formed outside the printing region. The fog toner formed outside the printing region becomes waste toner without being transferred to the recording material P and reaches the cleaning unit 17. Thus, waste toner in a secondary transfer step includes toner that remains without being secondarily transferred to the recording material P in the secondary transfer portion N2, and toner that becomes waste toner without being transferred to the recording material P. The specific contents of the printing region and the region outside the printing region continue to be described below.

FIG. 4B illustrates an example of a case where the document size is A4, whereas the output size is specified as A5. Since the output size is reduced compared to the document size, image patterns are reduced according to the ratio of the reduction. Then, the external apparatus 300 transmits image information corresponding to the A5 size to the controller 210. The control section 202 defines a printing region corresponding to the A5 size. A toner image formed based on an exposure pattern defined corresponding to an image forming region in the printing region is primarily transferred from the photosensitive drum 1 onto the intermediate transfer belt 10 in the primary transfer portion N1. Similarly to FIG. 4A, also in FIG. 4B, the toner image is not formed in a region corresponding to the image forming region in the printing region on the intermediate transfer belt 10, but fog toner is formed in a non-image forming region. Thus, the toner image and the fog toner are transferred from the intermediate transfer belt 10 to the recording material P of the A5 size in the secondary transfer portion N2, and residual toner not transferred becomes waste toner. On the intermediate transfer belt 10, fog toner is formed in a region according to the toner coating width of the development roller 42 illustrated in FIG. 4B. Thus, fog toner is also formed outside the printing region by an amount corresponding to the reduction and becomes waste toner without being transferred to the recording material P. In FIG. 4B, the printing region results in being smaller than that in FIG. 4A, and therefore, the amount of fog toner not transferred to the recording material P is greater than that in FIG. 4A.

### 4. Waste Toner Box

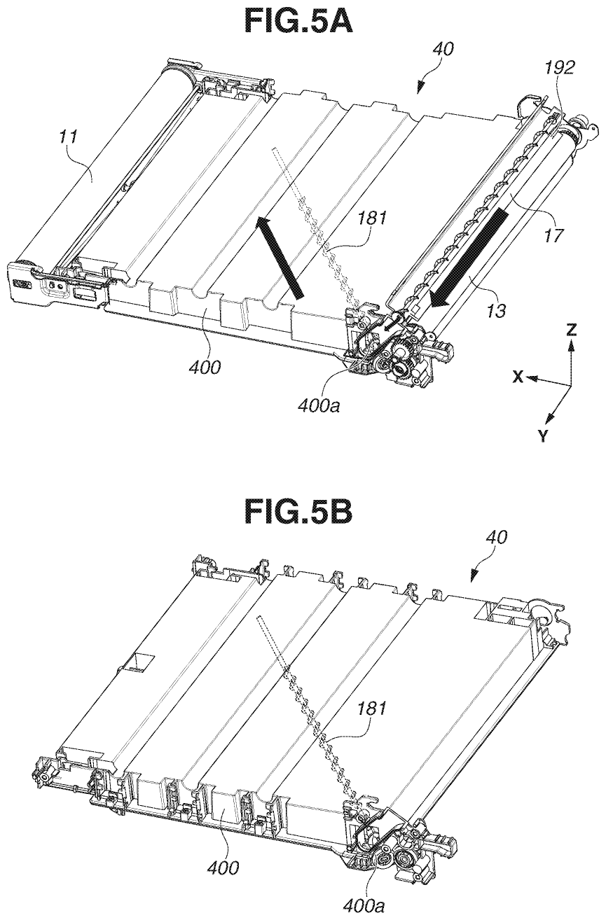

Next, a description is given of the configuration of the cleaning unit 17, the configuration of the waste toner box 400, and a conveyance mechanism for conveying waste toner in the cleaning unit 17 to the waste toner box 400. FIG. 5A is a perspective view of the intermediate transfer belt unit 40. FIG. 5B is a perspective view of the waste toner box 400 when only the waste toner box 400 is extracted from the intermediate transfer belt unit 40. FIG. 5B does not illustrate the cleaning unit 17, and FIGS. 5A and 5B do not illustrate the intermediate transfer belt 10. An arrow in FIG. 5A indicates the conveyance path of waste toner. Toner on the intermediate transfer belt 10 scraped by the cleaning blade 16 is conveyed in a +Y-direction illustrated in FIGS. 5A and 5B as a first conveyance member 192, in which a spiral conveyance portion (a screw) is provided in the axis direction of a rotation shaft, receives the rotation of the driving section 90 and rotates. Then, the toner is conveyed to the waste toner box 400 via a waste toner conveyance path provided in the intermediate transfer belt unit 40. This waste toner conveyed into the waste toner box 400 is stored in the waste toner box 400 as follows. The waste toner box 400 includes a second conveyance member 181 which extends from a waste toner inflow port 400a in the waste toner box 400 as a starting point and in which a spiral conveyance portion (a screw) is provided in the axis direction of a rotation shaft. The second conveyance member 181 receives the rotation of the driving section 90 and rotates, whereby the waste toner is conveyed toward the center in the waste toner box 400 while spreading on an XY-plane illustrated in FIG. 5A. Then, the waste toner box 400 illustrated in FIG. 5B is filled with the waste toner. In the present embodiment, the waste toner capacity of the waste toner box 400 is greater than that of the cleaning unit 17. As described above, the intermediate transfer belt unit 40 is configured to be replaceable relative to the image forming apparatus 100. That is, the waste toner box 400 is configured to be replaceable relative to the image forming apparatus 100.

### 5. Calculation of Amount of Waste Toner

### 5-1. Amount of Waste Toner when Printing is Performed on Recording Material of LTR Size

The basic idea of waste toner in the present embodiment is described.

Waste toner refers to residual toner remaining on the surface of the intermediate transfer belt 10 when the recording material P reaches the secondary transfer portion N2 and toner attached to the surface of the intermediate transfer belt 10 is transferred to the surface of the recording material P. Every time toner is transferred to the recording material P, not a little waste toner remaining on the surface of the intermediate transfer belt 10 is generated. The waste toner is classified broadly into two types. One type is transfer residual toner obtained by, according to the transfer of a toner image formed in an image forming region in a printing region, a part of the toner image remaining on the surface of the intermediate transfer belt 10 without being transferred. The other type is fog toner attached to a non-image forming region where the image is not formed. The fog toner is also classified broadly into two types. One type is fog toner remaining inside the printing region, i.e., on the surface of the intermediate transfer belt 10 that is in contact with the recording material P. The other type is fog toner remaining outside the printing region, i.e., on the surface of the intermediate transfer belt 10 that is not in contact with the recording material P. Regions where the transfer residual toner and the fog toner are generated will be described in detail below.

In the present embodiment, the transfer residual toner and the fog toner, i.e., the waste toner, are calculated as follows. Based on data on the amount of waste toner generated by a continuous printing operation and an intermittent printing operation, the unit amounts of the amount of waste toner inside the printing region and the amount of waste toner outside the printing region are calculated, and are saved in advance in the memory 201. Based on the data in the memory 201, the amount of waste toner inside the printing region and the amount of waste toner outside the printing region per job are calculated. The unit amount of waste toner inside the printing region is defined as the amount per pixel count and includes the amount of waste toner composed of transfer residual toner and fog toner. As the amount of waste toner composed of the fog toner, further, fog toner remaining on the surface of the intermediate transfer belt 10 that does not come into contact with the recording material P outside the printing region is added. The feature of the present embodiment is that this fog toner is added as the waste toner with high accuracy.

The waste toner inside the printing region includes fog toner that comes into contact with the recording material P and is present in an image formable region, and fog toner outside the image formable region. In the present embodiment, as described above, these types of fog toner are calculated together with transfer residual toner as waste toner. The image formable region refers to a region where a toner image can be actually formed on the surface of the recording material P. The toner image is formed by supplying toner from the development roller 42 to the surface of the photosensitive drum 1 on which a latent image is formed by the exposure device 3 exposing the surface. That is, a region where an electrostatic latent image can be formed on the surface of the photosensitive drum 1 by the exposure device 3 is defined as the image formable region.

Data on the amount of waste toner generated by a continuous printing operation and an intermittent printing operation may be acquired and saved in advance in the memory 201, and the amount of waste toner may be calculated taking into account a pre-rotation operation, a post-rotation operation, and an inter-sheet operation per job with respect to each user.

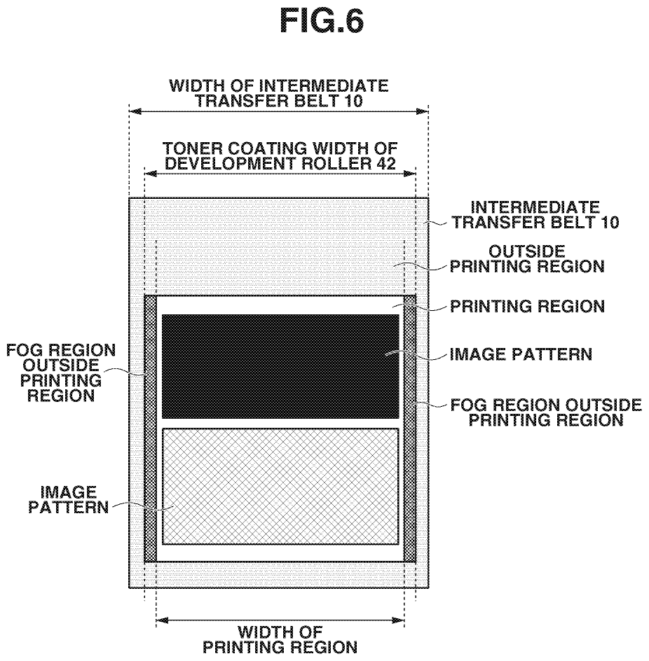

Next, with reference to FIGS. 6 to 9, a description is given of a method for calculating the amount of waste toner stored in the waste toner box 400 in a case where paper of the LTR size is passed as the recording material P.

As described with reference to FIG. 4, as waste toner, secondary transfer residual toner of image patterns and secondary transfer residual toner of fog toner become waste toner inside a printing region, and fog toner becomes waste toner without being secondarily transferred outside the printing region. The fog toner inside the printing region is secondarily transferred, and therefore, as the waste toner inside the printing region, the amount of the secondary transfer residual toner of the image patterns is greater than that of the secondary transfer residual toner of the fog toner. In view of this, in the present embodiment, the amount of waste toner is calculated according to the following Equation (1).

$$\begin{matrix}[ Math . 1 ] & \\ T = {\sum }_{j}^{4} \{ {\sum }_{n}^{α} ( {P}_{n} ) \} + {R}_{2} \times ( α - 1 ) + {R}_{1} & Equation ( 1 )\end{matrix}$$

In Equation (1), T represents the amount of waste toner per print job. The amount of waste toner with respect to each of the YMCK image stations is calculated, and the calculated amounts of waste toner are totaled by the first sequence sum Σ. When j=1, the amount of waste toner of Y is calculated. When j=2, the amount of waste toner of M is calculated. When j=3, the amount of waste toner of C is calculated. When j=4, the amount of waste toner of K is calculated.

α represents the number of printed sheets in the print job. Pₙ represents the amount of waste toner inside a printing region in the printing of an n-th sheet. This includes the amount of waste toner including secondary transfer residual toner of image patterns and secondary transfer residual toner of fog toner, and fog toner outside a printing region illustrated in FIG. 6 and is a value that changes according to the pixel amount of the image patterns.

With reference to FIGS. 6, 8, 14A, and 14B, the fog toner outside the printing region is described.

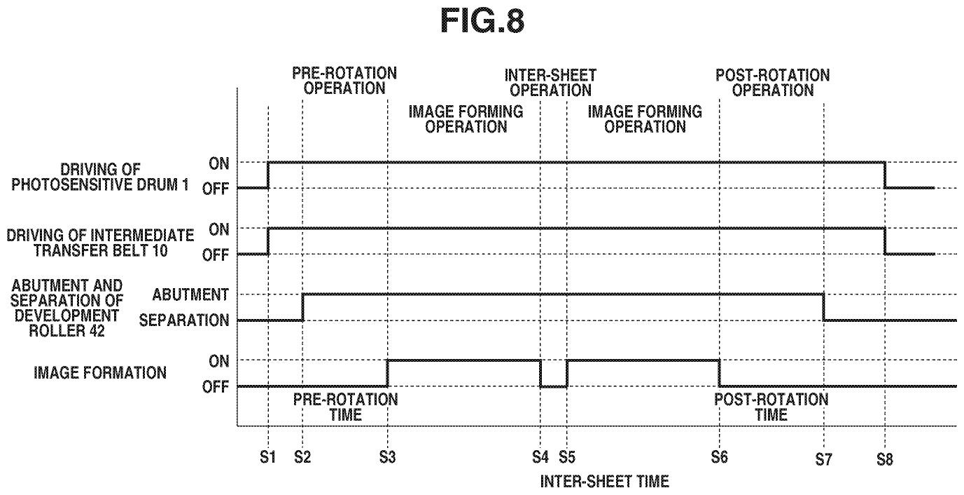

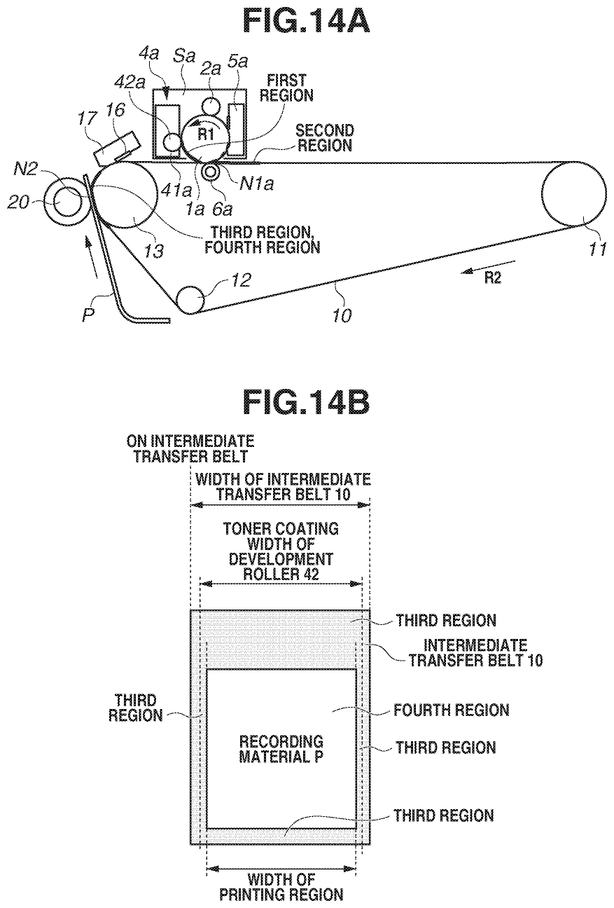

Although the details of FIG. 8 will be described below, FIG. 8 is a timing chart illustrating the states of various operations when printing is performed on two recording materials P of the LTR size in succession. FIGS. 14A and 14B illustrate what regions regions outside the printing region in FIG. 6 are. FIG. 14A illustrates a cross-sectional view of the image forming apparatus 100 centered on the intermediate transfer belt unit 40. FIG. 14B illustrates regions centered on the recording material P and the intermediate transfer belt 10. FIGS. 14A and 14B illustrate only portions necessary for description and illustrate only the yellow image forming section Sa among the image forming sections S. As an example, an image forming operation is described in sequence together with the motion of fog toner.

First, as illustrated in FIG. 8, when the control section 202 receives a print command from the controller 210, the control section 202 starts a print job and performs control to execute a pre-rotation operation. Then, the photosensitive drum 1 rotates, and the development roller 42 rotates while abutting the surface of the photosensitive drum 1. At this time, toner is borne on the surface of the development roller 42. In this state, the photosensitive drum 1 and the development roller 42 rotate while abutting each other, whereby not a little toner is attached to the surface of the photosensitive drum 1. This toner attached to the surface of the photosensitive drum 1 is referred to as “fog toner”. The present embodiment is directed to calculating the fog toner attached to this region of the photosensitive drum 1 with high accuracy. Further, it is very important to calculate fog toner outside the printing region with high accuracy.

First, regions are defined to obtain the fog toner outside the printing region with high accuracy. As illustrated in FIG. 14A, a region of the photosensitive drum 1 where the development roller 42 and the photosensitive drum 1 come into contact with each other and form a development portion is defined as a first region. The first region is a region where the fog toner that is attached to the photosensitive drum 1 by the development roller 42 and the photosensitive drum 1 rotating while abutting each other is present. To reduce this fog toner as much as possible, the control section 202 controls the potential difference in the development portion as follows. The control section 202 performs control to form a potential difference that causes an electrostatic force to act in the direction in which the toner charged to the negative polarity that is the normal polarity moves from the photosensitive drum 1 toward the development roller 42 on the surface of the photosensitive drum 1 charged to the dark potential Vd by the charging roller 2.

That is, the charging power supply 24 applies a charging voltage of −950 V to the charging roller 2, thereby forming a dark potential Vd of −550 V on the surface of the photosensitive drum 1. Then, the surface of the photosensitive drum 1 on which the dark potential Vd is formed and the development roller 42 to which a development voltage of −350 V is applied by the development power supply 25 abut each other, thereby forming an electric field of 200 V as a potential difference between the photosensitive drum 1 and the development roller 42. This potential difference of 200 V is referred to as a “back contrast”. When the back contrast is great, the toner having the positive polarity that is the toner having the opposite polarity to the normal polarity of the toner is likely to be attached to the surface of the photosensitive drum 1 on which the dark potential Vd is formed. On the other hand, when the back contrast is small, the toner charged to the negative polarity that is the normal polarity tends to be attached to the surface of the photosensitive drum 1 on which the dark potential Vd is formed. In the present embodiment, the reversal development method is employed. Thus, the control section 202 performs control so that the potential difference formed between the surface potential formed in the first region when the first region forms the development portion and the development roller 42 forms a potential difference that causes an electrostatic force to act in the direction in which the toner charged to the normal polarity moves from the photosensitive drum 1 toward the development roller 42.

Next, attention is paid to the primary transfer portion N1. A region of the intermediate transfer belt 10 where the first region indicated by a dotted line in FIG. 14A and a region of the intermediate transfer belt 10 forming the primary transfer portion N1 come into contact with each other as the photosensitive drum 1, to which the fog toner is attached, and the intermediate transfer belt 10 rotate is defined as a second region. This can define regions in a case where the fog toner attached to the surface of the photosensitive drum 1 moves to the surface of the intermediate transfer belt 10.

Next, a case is considered where the second region forms the secondary transfer portion N2 as the intermediate transfer belt 10 to which the fog toner is attached rotates. Although FIG. 14A illustrates only a part of the second region, portions of a third region and a fourth region in FIG. 14A result from the movement of the second region. In this case, within the second region, a region of the intermediate transfer belt 10 where the recording material P is not nipped between the secondary transfer roller 20 and the intermediate transfer belt 10 in the secondary transfer portion N2 is defined as a third region. That is, as illustrated in FIG. 14B, the third region is outside the printing region.

Then, a region of the intermediate transfer belt 10 where the recording material P is nipped between the secondary transfer roller 20 and the intermediate transfer belt 10 in the secondary transfer portion N2 is defined as a fourth region. That is, the fourth region is inside the printing region. The third and fourth regions are described in further detail. FIG. 14B illustrates the relationship between regions in the rotational direction of the intermediate transfer belt 10, i.e., the moving direction of the surface, and the longitudinal direction that is a direction orthogonal to the moving direction of the surface in the third and fourth regions. As illustrated in FIG. 14B, a region where the recording material P and the intermediate transfer belt 10 are not in contact with each other is defined as the third region, and a region where the recording material P and the intermediate transfer belt 10 are in contact with each other is defined as the fourth region. It is important to allocate fog toner attached to the third region as waste toner, taking into account the fog toner attached to the third region. As a matter of course, fog toner is also present in the fourth region, and therefore, transfer residual toner and fog toner are added by separating an image forming region and a non-image forming region that is a non-printing region.

Then, as will be described below, the control section 202 performs control to calculate residual toner in the third and fourth regions based on information regarding the sheet size.

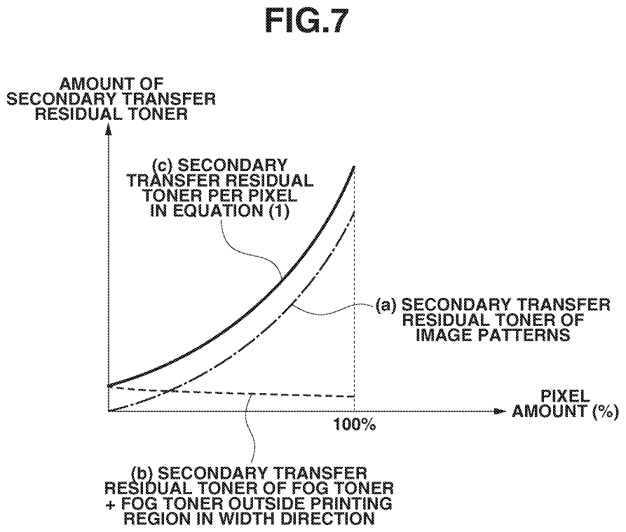

FIG. 7 is a graph illustrating the relationship between the number of pixel counts and the amount of waste toner inside the printing region.

The horizontal axis in FIG. 7 represents a pixel amount indicating the proportion of pixel counts. When the entire region of the printing region of the LTR size is exposed, the pixel amount is 100%. The vertical axis in FIG. 7 represents the amount of secondary transfer residual toner inside the printing region. In the present embodiment, since exposure data is 600 dpi, the LTR size has 5102 pixels×6590 pixels=33627379 pixels. In the present embodiment, when a so-called black solid image obtained by exposing the entire region of the printing region of the LTR size is formed, the pixel amount is 100%. When the pixel amount is 50%, a case is assumed where half of the black solid image is formed. Here, regarding the idea of a pixel amount of 50%, the manner of the generation of waste toner is almost unchanged between a case where the black solid image is formed in half of the region and a case where a halftone image having a lower gradation than the black solid image is formed in 100% of the region with half the pixel amount of the black solid image. That is, when the amounts of toner of the formed images are equal to each other, i.e., the pixel amounts of the images are equal to each other, the amounts of generation of secondary transfer residual toner hardly change. Therefore, the idea is applicable to both cases.

A line indicated as (a) in FIG. 7 is a line indicating the secondary transfer residual toner of the image patterns. The greater the pixel amount is, the greater the amount of the secondary transfer residual toner of the image patterns is. This is because the greater the pixel amount is, the greater the amount of toner used as the image patterns is. On the other hand, a line indicated as (b) in FIG. 7 is a line indicating the total of the secondary transfer residual toner of the fog toner and the fog toner outside the printing region in FIG. 6. The greater the pixel amount is, the smaller the total of the secondary transfer residual toner of the fog toner is. This is because the greater the pixel amount is, the greater the proportion of the image patterns to the image formable region is. In the present embodiment, the toner coating width of the development roller 42 is 220 mm, and the width of the recording material P of the LTR size is 216 mm. Thus, in regions having a width of 220 mm-216 mm=4 mm, waste toner due to fog toner is generated while the recording material P is passing through the secondary transfer portion N2. Thus, as illustrated in FIG. 7, the amounts of the fog toner generated in the fog regions outside the printing region illustrated in FIG. 6 and the secondary transfer residual toner of the fog toner generated inside the printing region are smaller than that of the secondary transfer residual toner of the image patterns. In view of this, in Equation (1), the secondary transfer residual toner of the fog toner when the pixel amount is 0% is formed in regions other than the image forming region where the image patterns are drawn, and an amount obtained by adding the secondary transfer residual toner of the fog toner to the secondary transfer residual toner of the image pattern is Pₙ. Then, the amount of waste toner is determined corresponding to a line as indicated as (c) in FIG. 7.

In Equation (1), R₂ represents the amount of fog toner outside the printing region at an inter-sheet interval. Thus, since α represents the number of printed sheets in the print job, a value obtained by multiplying the term of R₂ by the number of times of an inter-sheet operation (α−1) is the amount of fog toner corresponding to the number of printed sheets in the print job. R1 represents the amount of fog toner during the time in which the development roller 42 abuts the photosensitive drum 1 at timings before an image forming operation and after the image forming operation. R₂ and R₁ are calculated as follows. Every time the abutment time of the development roller 42 elapses by 5 ms, 5 ms is added to the abutment time, a development abutment time at the timing when the print job is completed is calculated, and the amount of fog toner is calculated in proportion to the development abutment time. As the amount of fog toner calculated in this case, the amount of toner per 5 ms is defined in advance also taking into account the attachment of the toner to the secondary transfer roller 20.

FIG. 8 is a timing chart illustrating the states of various operations when printing is performed on two recording materials P of the LTR size in succession. A description is given of the various operations when printing is performed on two recording materials P of the LTR size in succession. First, in step S1, the control section 202 performs control to rotationally drive the photosensitive drum 1 and the intermediate transfer belt 10. Then, in step S2, the control section 202 controls the development roller 42 to transition from the separation state to the abutment state. When the development roller 42 transitions to the abutment state, pre-rotation is started, and a pre-rotation operation is performed. When the pre-rotation operation ends, then in step S3, the control section 202 performs control to start an image forming operation. When the image forming operation on the first recording material P ends, and before transition is made to the image forming operation on the second recording material P, then in step S4, the control section 202 performs control to perform an inter-sheet operation. When the inter-sheet operation ends, then in step S5, the control section 202 performs control to perform the image forming operation on the second recording material P. When the image forming operation on the second recording material P ends, then in step S6, the control section 202 performs control to perform a post-rotation operation. When the post-rotation operation ends, then in step S7, the control section 202 controls the development roller 42 to transition from the abutment state to the separation state. After the development roller 42 is separated, then in step S8, the control section 202 performs control to stop the rotational driving of the photosensitive drum 1 and the intermediate transfer belt 10 and ends all the operations.

In the present embodiment, in FIG. 8, the time between steps S2 and S3, which is the time in which the pre-rotation operation after the abutment of the development roller 42 and until the start of the image forming operation is performed, is defined as a pre-rotation time. The time between steps S4 and S5, which is the time in which the inter-sheet operation after the end of the image forming operation on the first recording material P and until the start of the image forming operation on the second recording material P is performed, is defined as an inter-sheet time. Then, the time between steps S6 and S7, which is the time in which the post-rotation operation after the end of the image formation operation and until the separation of the development roller 42 is performed, is defined as a post-rotation time. An operation between steps S1 and S3 may be defined as a pre-rotation operation, or an operation between steps S6 and S8 may be defined as a post-rotation operation. The development abutment time in each operation may be counted. R1 in Equation (1) is calculated based on the sum of the pre-rotation time and the post-rotation time, and the inter-sheet time is used to calculate R₂. Although in the example of FIG. 8, the development rollers 42a, 42b, 42c, and 42d all perform abutment/separation operations at the same timing, the abutment/separation timings may be adjusted according to the timings of image formation of the respective colors depending on the driving mechanism for the abutment/separation operations.

In the present embodiment, Pₙ is the same amount of waste toner in each color when the pixel amount is the same. R₂ and R₁ are the same amounts of fog toner in each color when the times corresponding to R₂ and R₁ are the same. However, Pₙ, R₂, and R₁ can also be different values according to the properties of the toner of each color.

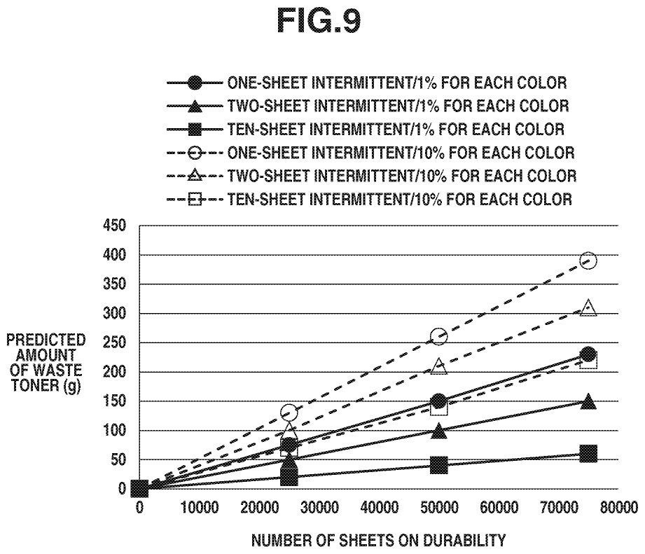

Next, a description is given of the calculation of the amount of waste toner when sheet passing durability was performed. FIG. 9 illustrates the predicted calculation results of the amount of waste toner in the waste toner box 400 when printing was performed on a total of 75000 sheets under the environment of a temperature of 23 °C and a humidity of 50%. These predicted calculation results are the predicted results when printing was performed using Vitality paper manufactured by Xerox Corporation as the paper type and a cartridge S having a toner filling amount of 150 g while replacing the cartridge S when the remaining amount of toner was 30 g.

For comparison, the amount of waste toner was calculated at a total of six levels based on three levels, namely a one-sheet intermittent mode, a two-sheet intermittent mode, and a ten-sheet intermittent mode as a print mode, and two levels, namely pixel amounts of 1% and 10% for each color. As illustrated in FIG. 9, the greater the pixel amount is, the greater the amount of waste toner is. This is because the amount of residual toner in image patterns that is not secondarily transferred to the recording material P is great. Even if images have the same pixel amount, the amounts of waste toner to be calculated are greatly different from each other depending on the difference in intermittent mode. This is because as described with reference to FIG. 8, the smaller the number of intermittent sheets is, the greater the execution frequencies of the pre-rotation operation and the post-rotation operation are. Thus, the amount of fog toner is great by an amount corresponding to this.

### 5-2. Amount of Waste Toner when Printing is Performed on Recording Material of A5 Size

Next, to describe the calculation of the amount of waste toner when printing is performed on a recording material of a size different from the case of the LTR size described in 5-1, as an example, a description is given of the calculation of the amount of waste toner when printing is performed on the recording material P of the A5 size.

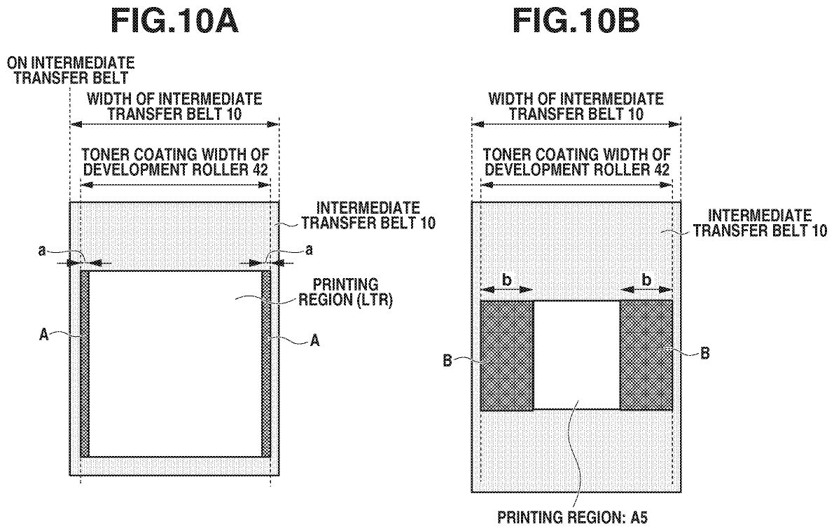

FIGS. 10A and 10B illustrate the comparison between printing regions of the LTR size (FIG. 10A) and the A5 size (FIG. 10B) on the intermediate transfer belt 10. Both in the moving direction of the intermediate transfer belt 10 and the width direction orthogonal to the moving direction, the widths of the A5 size in FIG. 10B are narrower than the widths of the LTR size in FIG. 10A. Thus, when a region A in FIG. 10A and a region B in FIG. 10B corresponding to the region outside the printing region that is the region outside the recording material P are compared with each other, the area of the region B is greater than the area of the region A. That is, the amount of fog toner generated in a region having a width b in FIG. 10B is greater than the amount of fog toner generated in a region having a width a in FIG. 10A. Accordingly, in the present embodiment, when the A5 size as illustrated in FIG. 10B is passed, fog toner in the width direction outside the printing region is also calculated.

Specifically, as illustrated in the following Equation (2), the fourth term taking into account the term of R₃ is added to Equation (1), thereby calculating the amount of waste toner also taking into account the amount of fog toner in the width direction.

$$\begin{matrix}[ Math . 2 ] & \\ T = {\sum }_{j}^{4} \{ {\sum }_{n}^{α} ( {P}_{n} ) \} + {R}_{2} \times ( α - 1 ) + {R}_{1} + {R}_{3} \times ( 1 - \frac{specified sheet width}{reference sheet width} ) & Equation ( 2 )\end{matrix}$$

In Equation (2), R₃ represents the amount of fog toner corresponding to the passing time of the specified sheet.

A reference sheet width is the LTR size and is 216 mm in the present embodiment.

A specified sheet width is the width of the recording sheet specified by the printer driver and is 148 mm in the case of the A5 size.

Thus, when the A5 size is passed, the term of R₃ in Equation (2) is calculated as follows.

R₃×(1−148/216)=0.315×R₃

As described above, when printing is performed on the A5 size, the amount of waste toner is calculated also taking into account the influence of fog toner in the width direction, whereby it is possible to calculate the amount of waste toner with higher accuracy.

Although in the present embodiment, the ratio of the width of the specified sheet to that of the LTR size as a reference is calculated to take into account the amount of fog toner in the width direction, the LTR size may not need to be used as a reference. For example, the toner coating width of the development roller 42 illustrated in FIGS. 10A and 10B may be used as a reference. When the toner coating width of the development roller 42 is used as a reference, the amount of waste toner can be calculated by rewriting Equation (1) as follows.

$$\begin{matrix}[ Math . 3 ] & \\ T = {\sum }_{j}^{4} \{ {\sum }_{n}^{α} ( {P}_{n} ) \} + {R}_{2} \times ( α - 1 ) + {R}_{1} + {R}_{3} \times ( 1 - \frac{specified sheet width}{toner coating width} ) & Equation ( 3 )\end{matrix}$$

In Equation (3), the fourth term is the amount of fog toner on a specified sheet n. In the examples of FIGS. 10A and 10B, the fourth term is the amount of fog toner corresponding to the region A in the case of the LTR size, and the fourth term is the amount of fog toner corresponding to the region B in the case of the A5 size.

Although R₁, R₂, and R₃ in Equations (2) and (3) represent the amounts of fog toner corresponding to the pre-rotation operation and the post-rotation operation, the inter-sheet operation, and the time in which the recording material P passes through the printing region, respectively, the amounts of fog toner generated per unit time are the same. Accordingly, the calculation of the amount of waste toner can also be represented as in Equation (4).

$$\begin{matrix}[ Math . 4 ] & \\ T = {\sum }_{j}^{4} \{ {\sum }_{n}^{α} ( {P}_{n} ) \} + {\sum }_{t} {R}_{n} & Equation ( 4 )\end{matrix}$$

In Equation (4), the second term is the total amount of the amounts of fog toner per print job. Rₙ is the amount of fog toner per unit time. For example, the amount of fog toner in which the development abutment time is 5 ms can be the unit.

Regarding Rₙ in Equation (4), the amount of fog toner is calculated according to ΣₜRₙ×(1−specified sheet width/reference sheet width) instead of ΣₜRₙ while the recording material P is passing through the printing region, i.e., when the recording material P is present in the main scanning direction.

Also in Equation (3), the amount of fog toner generated per unit time can also be similarly calculated.

Although Pₙ in Equations (1) to (4) is obtained by calculating the amount of toner in the print job in each color and then adding the amount of toner in another color, for example, calculation may be performed so that every time printing is performed on a single recording material P, Pₙ in each color is added.

### 5-3. Consideration of Change in Transfer Efficiency

In the present disclosure, a method for calculating waste toner due to the toner passing through the secondary transfer portion N2 is described. However, a so-called secondary transfer efficiency, which is the degree of transfer of the toner on the intermediate transfer belt 10 to the recording material P, may change according to the print environment, the amount of water contained in the recording material P, or the like.

Accordingly, to calculate the amount of waste toner with higher accuracy, parameters for taking into account a change in the secondary transfer efficiency are set, whereby it is possible to calculate the amount of waste toner with higher accuracy.

Equation (5) is a calculation equation for the amount of waste toner obtained by adding parameters t and ε for taking into account a change in the secondary transfer efficiency to equation (2).

$$\begin{matrix}[ Math . 5 ] & \\ T = [ {\sum }_{j}^{4} \{ {\sum }_{n}^{α} ( t \times {P}_{n} ) \} + {R}_{2} \times ( α - 1 ) + {R}_{1} + {R}_{3} \times ( 1 - \frac{specified sheet width}{reference sheet width} ) ] \times ε & Equation ( 5 )\end{matrix}$$

In Equation (5), ε is a parameter to be adjusted according to a change in the print environment, and for example, is set according to the absolute amount of water detected in the image forming apparatus 100. That is, when the print environment changes, a change in the resistance of a conductive member of the intermediate transfer belt 10, the development roller 42, or the like or a change in the amount of water contained in the toner in the development container 41 occurs. Thus, the amount of fog toner and the secondary transfer efficiency change.

ε is provided so that the calculated value of the amount of waste toner can be adjusted taking into account these changes. Particularly, ε may be changed based on the detection result of the environment sensor 207. In the present embodiment, ¿ is 1.0 under each of the environment of a temperature of 23 °C and a humidity of 50% and the environment of a temperature of 15 °C and a humidity of 10%, and is 1.5 under the environment of a temperature of 30 °C and a humidity of 90%. This is because the transfer efficiency is poor and fog is severe under the environment of a temperature of 30 °C and a humidity of 90%. Thus, the environment of a temperature of 30 °C and a humidity of 90% is more weighted than the other environments. The values in each environment may be linearly interpolated based on the absolute amount of water, or fixed values may be used.

In Equation (5), t is a parameter used to multiply Pₙ and is a parameter set to mainly take into account a change in the secondary transfer efficiency that changes according to a change in the amount of water contained in the recording material P.

The amount of water of the recording material P changes according to the print environment, the storage state of the recording material P, or the like, and therefore, a variety of methods for setting the value of t are possible. For example, it is possible to set a value assuming the secondary transfer efficiency in a case where the storage state of the recording material P is the state where the recording material P is left bare in the print environment, and change the value of the parameter according to the absolute amount of water detected in the image forming apparatus 100. As another method, it is also possible to detect the relationship between the secondary transfer current and the secondary transfer voltage while the first recording material P subjected to printing is passing through the secondary transfer portion N2, and set the value of the parameter according to the result of the detection.

The parameter ε can also be divided into ε₁ and ε₂ between Pₙ and R₁, R₂, and R₃ as in Equation (6). In a case where the parameter ε is divided into ε₁ and ε₂, for example, ε₁>ε₂ under the environment of a temperature of 30 °C and a humidity of 90%, and 81<82 under the environment of a temperature of 15 °C and a humidity of 10%. This is because the transfer efficiency has a strong influence in the case of a temperature of 30 °C and a humidity of 90%, and fog has a strong influence in the case of the environment of a temperature of 15 °C and a humidity of 10%. Thus, it is desirable to set ε₁ and ε₂ so that the above relational Equations hold.

$$\begin{matrix}[ Math . 6 ] & \\ T = [ {\sum }_{j}^{4} \{ {\sum }_{n}^{α} ( t \times {P}_{n} ) \} ] \times {ε}_{1} + \{ {R}_{2} \times ( α - 1 ) + {R}_{1} + {R}_{3} \times ( 1 - \frac{specified sheet width}{reference sheet width} ) \} \times {ε}_{2} & Equation ( 6 )\end{matrix}$$

It is also possible to apply the parameters t and ε and the like to Equation (4).

### 5-4. Consideration of Changes Due to Degradation of Durability of Toner

Next, a description is given of the consideration of the influences of changes in the secondary transfer efficiency and the amount of fog toner that change due to the degradation of the durability of the toner.

The unused toner remaining without being developed in the development container 41 gradually deteriorates through durability use. As specific degradation, the peeling off of an external additive added to the toner base, the deformation of the shape of the toner base, or the like is possible. Due to these types of degradation, the deterioration of the secondary transfer efficiency, an increase in the amount of fog toner, or the like may occur.

Accordingly, as illustrated in Equation (7), a parameter λ representing a change in the amount of waste toner due to the degradation of the toner is inserted into Equation (5).

$$\begin{matrix}[ Math . 7 ] & \\ T = [ {\sum }_{j}^{4} \{ {\sum }_{n}^{α} ( t \times {P}_{n} ) \} + {R}_{2} \times ( α - 1 ) + {R}_{1} + {R}_{3} \times ( 1 - \frac{specified sheet width}{reference sheet width} ) ] \times ε \times λ & Equation ( 7 )\end{matrix}$$

In Equation (7), λ is a parameter to be adjusted according to the state of the degradation of the toner, and for example, can be set based on a degradation index or the like defined taking into account a parameter regarding the degradation of the toner, such as the remaining amount of toner in the development container 41, the number of revolutions of the development roller 42, or the like.

The parameter λ can also be divided into λ₁ and λ₂ between Pₙ and R₁, R₂, and R₃ as in Equation (8).

$$\begin{matrix}[ Math . 8 ] & \\ T = [ {\sum }_{j}^{4} \{ {\sum }_{n}^{α} ( t \times {P}_{n} ) \} ] \times {ε}_{1} \times {λ}_{1} + \{ {R}_{2} \times ( α - 1 ) + {R}_{1} + {R}_{3} \times ( 1 - \frac{specified sheet width}{reference sheet width} ) \} \times {ε}_{2} \times {λ}_{2} & Equation ( 8 )\end{matrix}$$

It is also possible to apply the parameter λ to Equation (4). The parameter λ may also be changed according to the environment as in Equation (6).

### 5-5. Notification Regarding Capacity Life in Waste Toner Box

In the present embodiment, regarding the amount of waste toner calculated by the above method, when the amount of waste toner based on information regarding the amount of waste toner in the waste toner box 400 is regarded as 100%, the control section 202 outputs a life notification signal to the controller 210. For example, the controller 210 can issue a notification regarding the replacement of the intermediate transfer belt unit 40 to the printer driver installed on the PC 300 and enable the user or the operator to replace the intermediate transfer belt unit 40.

As a method for issuing a notification regarding the state of the waste toner box 400, a notification is issued not only when the amount of waste toner is 100%, but a notification regarding progress can also be issued. For example, every time the remaining capacity is updated by 5%, information regarding which a notification is given can also be updated. Then, at the timing when the remaining capacity is 10%, i.e., at the timing when the amount of waste toner is 90%, a notification regarding a recommendation for the replacement of the intermediate transfer belt unit 40 can also be issued. As is clear from the above, the amount of waste toner may be considered as a reference, or the remaining capacity may be considered as a reference. That is, when a certain predetermined amount regarding waste toner crosses a threshold, a trigger may be set, and a notification may be issued. A configuration in which a value to be monitored increases and a configuration in which a value to be monitored decreases are both applicable to the configuration of the present embodiment.

### 5-6. Variations

As described above, in the present embodiment, to calculate the amount of waste toner in the waste toner box 400 placed in the intermediate transfer belt unit 40, the amount of waste toner generated in each of regions inside and outside a printing region is calculated, whereby it is possible to calculate the amount of waste toner with high accuracy.

In the present embodiment, as described with reference to FIG. 8, regarding the configuration in which the development roller 42 can perform the abutment/separation operation with respect to the photosensitive drum 1, the method for calculating the amount of waste toner has been described. However, the content of the present disclosure can also be applied to an image forming apparatus which does not include the abutment/separation mechanism 80 and in which the development roller 42 always abuts the photosensitive drum 1. In the image forming apparatus in which the development roller 42 always abuts the photosensitive drum 1, more fog toner is generated than that in the configuration in which the development roller 42 can perform the abutment/separation operation. Thus, as described in the present embodiment, it is more important to calculate the amount of fog toner generated outside a printing region, taking into account the amount of fog toner generated outside the printing region as the amount of waste toner to detect the amount of waste toner with high accuracy.

Although in the present embodiment, the details of the method for calculating the amount of waste toner for the color image forming apparatus 100 as illustrated in FIG. 1 have been described, the content of the present disclosure can be applied not only to a color image forming apparatus. For example, the content of the present disclosure can also be similarly applied to a monochrome image forming apparatus. In the case of the monochrome image forming apparatus, a toner image is transferred directly from the photosensitive drum 1 to the recording material P, but a printing region can be defined similarly to the color image forming apparatus. Thus, each of the amounts of waste toner generated inside and outside the printing region can be calculated.

In the present embodiment, in the above description, when the output size is smaller than the document size, the image size is reduced. However, the usefulness of the present disclosure does not change even if the image size is not reduced. A printing region is defined according to the output size, and a document image that is not reduced is formed in the printing region. Thus, the amount of waste toner may be calculated according to the result of counting the pixel amount based on a toner image. Although in the present embodiment, the waste toner box 400 is contained in the intermediate transfer belt unit 40, the usefulness of the present disclosure does not change even if the waste toner box 400 is configured independently of the intermediate transfer belt unit 40.

The features of the image forming apparatus 100 according to the first embodiment are as follows. The image forming apparatus 100 includes a photosensitive drum 1 as an image bearing member, and a charging roller 2 as a charging member that charges a surface of the photosensitive drum 1.

The image forming apparatus 100 includes a development container 41 that stores toner, and a development roller 42 as a developer bearing member that forms a development portion by coming into contact with the photosensitive drum 1 and supplies the toner charged to a normal polarity to the surface of the photosensitive drum 1 in the development portion. The image forming apparatus 100 includes a development power supply 25 as a development voltage application unit that applies a development voltage to the development roller 42. The image forming apparatus 100 includes an intermediate transfer belt 10 which forms a primary transfer portion N1 by coming into contact with the photosensitive drum 1 and to which the toner is transferred from the photosensitive drum 1 in the primary transfer portion N1. The image forming apparatus 100 includes a secondary transfer roller 20 as a secondary transfer member that forms a secondary transfer portion N2 by coming into contact with the intermediate transfer belt 10 and transfers the toner transferred to a surface of the intermediate transfer belt 10 to a recording material P in the secondary transfer portion N2. The image forming apparatus 100 includes a cleaning blade 16 as a collection member that collects residual toner remaining on the surface of the intermediate transfer belt 10 without being transferred to the recording material P in the secondary transfer portion N2. The image forming apparatus 100 includes a cleaning unit 17 as a first toner collection container that stores the residual toner collected by the cleaning blade 16. Then, the image forming apparatus 100 includes the waste toner box 400 as a second toner collection container that stores waste toner conveyed from the cleaning unit 17 by a screw 192 as a first conveyance member and a screw 181 as a second conveyance member. The waste toner box 400 is provided in the intermediate transfer belt unit 40 and placed on an inner side of the intermediate transfer belt 10. Further, the image forming apparatus 100 includes a controller 210 as an acquisition section that acquires information regarding a sheet size of the recording material P. The controller 210 calculates an amount of the waste toner based on the information regarding the sheet size of the recording material P and information regarding the waste toner that is the toner that remains on the surface of the intermediate transfer belt 10 and passes through the secondary transfer portion N2. To this end, the image forming apparatus 100 includes a waste toner amount calculation section 205 that calculates amounts of residual toner that would be stored in the first toner collection container 17 and the second toner collection container 400. The image forming apparatus 100 includes a driving section 90 that rotates the photosensitive drum 1 and the intermediate transfer belt 10, and a control section 202 that controls the development power supply 25 and the driving section 90.

A region of the photosensitive drum 1 where the development roller 42 and the photosensitive drum 1 form a development portion by coming into contact with each other as the photosensitive drum 1 rotates is defined as a first region. A region of the intermediate transfer belt 10 that forms the primary transfer portion N1 with the first region as the photosensitive drum 1 and the intermediate transfer belt 10 rotate is defined as a second region. In a case where the second region forms the secondary transfer portion N2 as the intermediate transfer belt 10 rotates, within the second region, a region of the intermediate transfer belt 10 where the recording material P is not nipped between the secondary transfer roller 20 and the intermediate transfer belt 10 in the secondary transfer portion N2 is defined as a third region. A region of the intermediate transfer belt 10 where the recording material P is nipped between the secondary transfer roller 20 and the intermediate transfer belt 10 in the secondary transfer portion N2 is defined as a fourth region.

In the present embodiment, the control section 202 controls a potential difference formed between a surface potential formed in the first region in a case where the first region forms the development portion and the development roller 42 as follows. The control section 202 performs control so that the potential difference is a potential difference that causes an electrostatic force to act in a direction in which the toner charged to the normal polarity moves from the photosensitive drum 1 toward the development roller 42. Then, the control section 202 performs control to calculate the residual toner in the third and fourth regions based on the information regarding the sheet size.

The control section 202 performs control to calculate the residual toner in the third region based on information regarding a time during which the photosensitive drum 1 and the development roller 42 are rotating in contact with each other. The control section 202 performs control so that a pre-rotation operation in which the photosensitive drum 1 and the development roller 42 rotate in contact with each other can be executed before an image forming operation. Then, the control section 202 performs control to calculate the residual toner in the third region in the pre-rotation operation. The control section 202 performs control so that a post-rotation operation in which the photosensitive drum 1 and the development roller 42 rotate in contact with each other can be executed after the image forming operation. Then, the control section 202 performs control to calculate the residual toner in the third region in the post-rotation operation. The control section 202 performs control so that an inter-sheet operation in which the photosensitive drum 1 and the development roller 42 rotate in contact with each other can be executed after the image forming operation is executed on a first recording material P and before the image forming operation is executed on a second recording material P subsequent to the first recording material P. Then, the control section 202 performs control to calculate the residual toner in the third region in the inter-sheet operation.

Based on the above, it is possible to predict the amount of waste toner in the waste toner box with high accuracy.

In the first embodiment, the method for specifying the size of the recording material P in the printer driver mounted on the external apparatus 300 and for calculating the amount of waste toner according to the specified size has been described. When, however, the size of the recording material P actually set by the user and the size specified by the printer driver are different from each other, a printing region of a size different from the size of the set recording material P is defined. In this case, an error may occur in the calculation of the amount of waste toner.

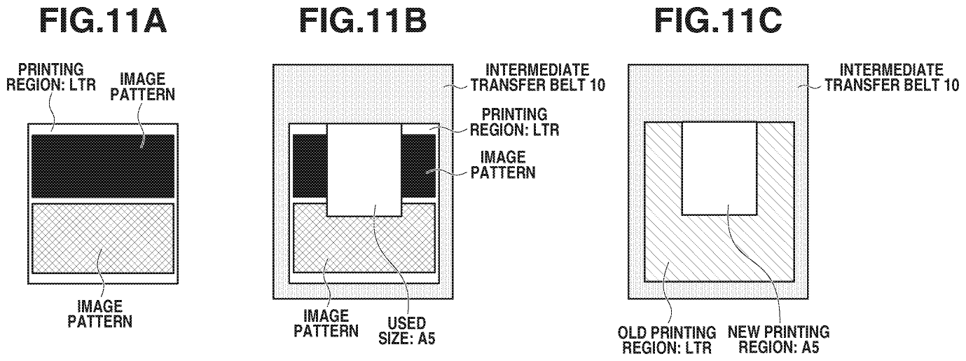

FIGS. 11A to 11C illustrate an example of a case where the specified size of the recording material P specified by the printer driver is larger than the size of the actually used recording material P. FIGS. 11A to 11C illustrate the state of a case where the specified size is the LTR size, and the size of the actually used recording material P is the A5 size. FIG. 11A illustrates the relationship between a printing region and image patterns in the output size in a case where the recording material P is set to the LTR size, and the image patterns are placed inside the printing region of the LTR size. FIG. 11B illustrates the relationship between regions on the intermediate transfer belt 10. FIG. 11B illustrates the state where the size of a printing region is the LTR size, whereas the size of the used recording material P is the A5 size, and therefore, image patterns are formed according to the printing region defined in a region of a size larger than or equal to the size of the recording material P.

In this case, the amount of waste toner is calculated according to Equations (1) to (8) on the premise of the LTR size. However, outside the range of the A5 size, toner is collected into the waste toner box 400 without the image patterns being transferred to the recording material P. Thus, the amount of waste toner actually collected into the waste toner box 400 is greater than the calculated value of the amount of waste toner, and the risk of leakage of waste toner from the waste toner box 400 increases.

Accordingly, in a second embodiment, a description is given of a method for detecting the size of the recording material P actually used by the user and calculating the amount of waste toner based on the result of the detection of the size.

In the present embodiment, to detect the size of the recording material P, a sheet size detection section 206 as a second acquisition section including a sheet length detection sensor that detects the length in the conveyance direction of the recording material P and a sheet width detection sensor that detects the width of the recording material P is separately provided.

For example, the sheet length detection sensor is placed upstream of the secondary transfer portion N2 in the conveyance direction of the recording material P. In the present embodiment, a recording material front end position correction shutter (not illustrated) installed to adjust the front end position in the conveyance direction of the recording material P doubles as the sheet length detection sensor and measures the sheet length by recording a shutter opening time during which the recording material P is passing through the recording material front end position correction shutter. The sheet length detection sensor may have the above configuration, and the sensor may be placed independently of the recording material front end position correction shutter. For example, an optical sensor may be used.

Next, a method for detecting the width of the recording material P is described.

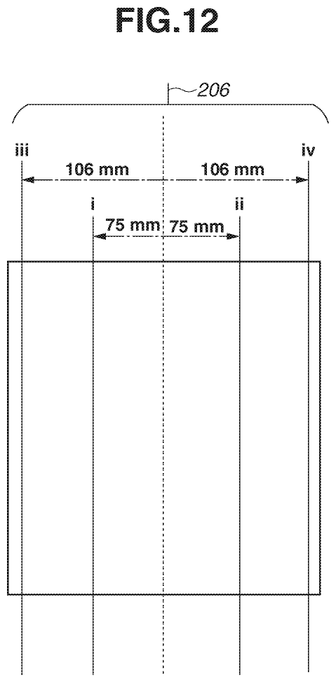

FIG. 12 illustrates the placement of the sheet size detection section 206 including the sheet width detection sensor according to the present embodiment, and a total of four sensors are placed. The four sensors are placed at positions downstream of a sheet feeding roller 50 in the sheet conveyance direction (not illustrated) and also placed symmetrically with respect to the center in the width direction of the cassette 51. For example, as the method of the sensor, a shutter mechanism, an optical sensor, or the like is possible. In FIG. 12, the distance between sensors i and ii is 150 mm, and the distance between sensors iii and iv is 212 mm.

Since the width of the recording material P of the A5 size is 148 mm, when the recording material P of the A5 size is conveyed, none of the sensors i to iv detects the recording material P. Accordingly, in the present embodiment, when all the sensors i to iv do not detect the recording material P, the control section 202 determines that the size of the recording material P in use is the A5 size.

Since the width of the recording material P of the A4 size is 210 mm, when the recording material P of the A4 size is conveyed, the sensors i and ii detect the recording material P, but the sensors iii and iv do not detect the recording material P. Accordingly, in the present embodiment, when the sensors i and ii detect the recording material P, and the sensors iii and iv do not detect the recording material P, the control section 202 determines that the size of the recording material P in use is the A4 size.

Since the width of the recording material P of the LTR size is 216 mm, when the recording material P of the LTR size is conveyed, all the sensors i, ii, iii, and iv detect the recording material P. Accordingly, in the present embodiment, when all the sensors i, ii, iii, and iv detect the recording material P, the control section 202 determines that the size of the recording material P in use is the LTR size.

Next, as an example, a description is given of a method for calculating the amount of waste toner when the size of the recording material P is determined as the A5 size by the detection of the sheet size detection section 206.

FIG. 11C illustrates regions when the control section 202 determines that the size of the actual recording material P is the A5 size. For convenience of description, FIG. 11C illustrates the printing region of the LTR size set by the printer driver as an old printing region and illustrates a newly set printing region of the A5 size as a new printing region. The amount of waste toner is calculated according to Equation (9) for the old printing region, the new printing region, and other regions.

$$\begin{matrix}[ Math . 9 ] & \\ T = {\sum }_{j}^{4} \{ {\sum }_{n}^{α} {P}_{n} ( 1 + m ) \} + {R}_{2} \times ( α - 1 ) + {R}_{1} & Equation ( 9 )\end{matrix}$$

In Equation (9), Pₙ represents the amount of waste toner in the new printing region and represents waste toner composed of secondary transfer residual toner calculated according to the pixel amount of the region.

In Equation (9), mPₙ represents the amount of waste toner in the old printing region and is calculated according to the pixel amount of the region. The toner represented by mPₙ becomes waste toner without being secondarily transferred, and therefore, the amount of waste toner mPₙ per pixel amount is greater than the amount of waste toner Pₙ per pixel amount. Thus, mPₙ is the amount of waste toner obtained by multiplying m as a coefficient. As the value of m, a value taking into account the secondary transfer efficiency and the attachment of toner to the secondary transfer roller 20 is set, and for example, a value such as m=10 is used.

In Equation (9), R₁ and R₂ represent the amounts of waste toner composed of fog toner in regions other than the old printing region and the new printing region, and similarly to the first embodiment, represent the amounts of waste toner according to the time in which the development roller 42 abuts the photosensitive drum 1.

Next, a case is described where the size of the actually used recording material P is larger than the size of the recording material P specified by the printer driver.

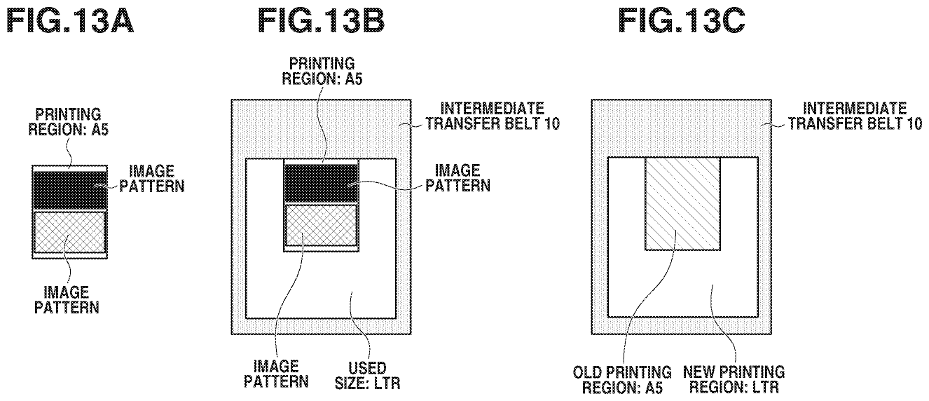

FIGS. 13A to 13C are diagrams illustrating regions when, as an example, the size of the recording material P specified by the printer driver is the A5 size, and the size of the actually used recording material P is the LTR size.

FIG. 13A illustrates the relationship between a printing region and image patterns in the output size in a case where the recording material P is set to the A5 size, and the image patterns are placed inside the printing region of the A5 size. FIG. 13B illustrates the relationship between regions on the intermediate transfer belt 10. FIG. 13B illustrates the state where the size of a printing region is the A5 size, whereas the size of the used recording material P is the LTR size, and therefore, the printing region is included in a region of the size of the recording material P.

FIG. 13C illustrates regions when it is determined that the size of the recording material P is the LTR size by the detection of the sheet size detection section 206. For convenience of description, FIG. 13C illustrates the printing region of the A5 size set by the printer driver as an old printing region and illustrates a newly set printing region of the LTR size as a new printing region. The amount of waste toner is calculated according to Equation (10) for the old printing region, the new printing region, and other regions.

$$\begin{matrix}[ Math . 10 ] & \\ T = {\sum }_{j}^{4} \{ {\sum }_{n}^{α} ( {P}_{n} ) \} + {R}_{2} \times ( α - 1 ) + {R}_{1} + {R}_{3} \times ( 1 - \frac{detected sheet width}{reference sheet width} ) & Equation ( 10 )\end{matrix}$$

Equation (10) is similar to Equation (2), but is different from Equation (2) in that in Equation (2), the fourth term is the specified sheet width and is the sheet width set by the printer driver, whereas in Equation (10), the fourth term is the detected sheet width determined by the detection of the sheet size detection section 206.

In Equation (10), Pₙ represents the amount of waste toner in the new printing region and represents waste toner composed of secondary transfer residual toner calculated according to the pixel amount of the region.

In Equation (10), R₁, R₂, and R₃ represent the amounts of waste toner composed of fog toner in regions other than the old printing region and the new printing region, and similarly to the first embodiment, represent the amounts of waste toner according to the time in which the development roller 42 abuts the photosensitive drum 1.

In the case of FIGS. 13A to 13C, in the new printing region, a toner image is not formed, and only fog toner is present. The fog toner in the new printing region is collected as secondary transfer residual toner into the waste toner box 400, and therefore, the amount of waste toner is smaller than that in the old printing region. Thus, in the case of FIGS. 13A to 13C, even if the amount of waste toner is calculated for the old printing region, i.e., according to Equation (2), the leakage of toner is less likely to occur in the waste toner box 400. Thus, according to the desired calculation accuracy of the amount of waste toner, it may be determined whether to calculate the amount of waste toner according to Equation (10) or calculate the amount of waste toner according to Equation (2).

As described above, in the present embodiment, when the size of the recording material P specified by the printer driver and the size of the actually used recording material P are different from each other, the amount of waste toner is calculated based on the size of the recording material P determined by the sheet size detection section 206 as a detection sensor. It is also possible to apply Equations (9) and (10) for calculating the amount of waste toner described in the present embodiment to calculation Equations taking into account the influences of changes in the transfer efficiency and the degradation of the durability of the toner as in Equations (3) to (8) described in the first embodiment.

According to the present disclosure, it is possible to predict the amount of waste toner in a waste toner box taking into account fog toner with high accuracy.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-074884, filed Apr. 28, 2025, which is hereby incorporated by reference herein in its entirety.

What is claimed is:

1. An image forming apparatus that executes an image forming operation for forming an image on a recording material, the image forming apparatus comprising:
an image bearing member;
a charging member configured to charge a surface of the image bearing member;
a development container configured to store toner;
a developer bearing member configured to form a development portion by coming into contact with the image bearing member and to supply the toner charged to a normal polarity to the surface of the image bearing member in the development portion;
a development voltage application section configured to apply a development voltage to the developer bearing member;
an intermediate transfer member configured to form a primary transfer portion by coming into contact with the image bearing member and to which the toner is transferred from the image bearing member in the primary transfer portion;
a transfer member configured to form a secondary transfer portion by coming into contact with the intermediate transfer member and to transfer the toner transferred to a surface of the intermediate transfer member to a recording material in the secondary transfer portion;
a collection member configured to collect residual toner remaining on the surface of the intermediate transfer member without being transferred to the recording material in the secondary transfer portion;
a toner storage section configured to store the residual toner collected by the collection member;
a calculation section configured to calculate an amount of the residual toner stored in the toner storage section;
a driving section configured to rotate the image bearing member and the intermediate transfer member; and
a control section configured to control the development voltage application section and the driving section,
wherein a region of the image bearing member where the developer bearing member and the image bearing member come into contact with each other to form the development portion as the image bearing member rotates is defined as a first region,
wherein a region of the intermediate transfer member that forms the primary transfer portion with the first region as the image bearing member and the intermediate transfer member rotate is defined as a second region,
wherein, in a case where the second region forms the secondary transfer portion as the intermediate transfer member rotates, within the second region, a region of the intermediate transfer member where the transfer member and the intermediate transfer member come into contact with each other in the secondary transfer portion is defined as a third region,
wherein the control section performs control so that a potential difference formed between the developer bearing member and a surface potential formed in the first region in a case where the first region forms the development portion is a potential difference that causes an electrostatic force to act in a direction in which the toner charged to the normal polarity moves from the image bearing member toward the developer bearing member, and
wherein the control section performs control to calculate the residual toner in the third region.

2. The image forming apparatus according to claim 1, wherein the control section performs control to calculate the residual toner in the third region based on information regarding a time during which the image bearing member and the developer bearing member are rotating in contact with each other.

3. The image forming apparatus according to claim 1, further comprising an acquisition section configured to acquire information regarding a sheet size of the recording material,
wherein the control section performs control to calculate the residual toner in the third region based on the information.

4. The image forming apparatus according to claim 3,
wherein, in the image forming operation, a region of the intermediate transfer member where the recording material is nipped between the transfer member and the intermediate transfer member in the secondary transfer portion is defined as a fourth region, and
wherein the control section performs control to calculate the residual toner in the fourth region based on the information.

5. The image forming apparatus according to claim 1,
wherein the control section performs control so that a pre-rotation operation in which the image bearing member and the developer bearing member rotate in contact with each other can be executed before the image forming operation, and
wherein the control section performs control to calculate the residual toner in the third region in the pre-rotation operation.

6. The image forming apparatus according to claim 1,
wherein the control section performs control so that a post-rotation operation in which the image bearing member and the developer bearing member rotate in contact with each other can be executed after the image forming operation, and
wherein the control section performs control to calculate the residual toner in the third region in the post-rotation operation.

7. The image forming apparatus according to claim 1,
wherein the control section performs control so that an inter-sheet operation in which the image bearing member and the developer bearing member rotate in contact with each other can be executed after the image forming operation is executed on a first recording material and before the image forming operation is executed on a second recording material subsequent to the first recording material, and
wherein the control section performs control to calculate the residual toner in the third region in the inter-sheet operation.
